(19) United States
(12) Patent Application Publication
(10) Pub. No.: US 2026/0009839 A1
(43) Pub. Date: Jan. 8, 2026

(54) MANAGEABILITY RECEIPT TLV FOR CHIPLET LIFECYCLE EVENTS IN MULTI-DIE SYSTEMS

(71) Applicant: Maximilian Ralph Peter von Liechtenstein, Douglas (IM)

(72) Inventor: Maximilian Ralph Peter von Liechtenstein, Douglas (IM)

(21) Appl. No.: 19/323,773

(22) Filed: Sep. 9, 2025

(51) Int. Cl. G01R 31/26; G06F 21/60

(52) U.S. Cl. CPC G01R 31/2642; G06F 21/602

(57) ABSTRACT

Systems and methods provide manageability receipts for chiplet lifecycle state transitions in multi-die packages. Upon detecting a transition (e.g., discovery->enumeration, enumeration->authentication, authentication->enablement, enablement->reset/quiescence, or quiescence->retirement), logic unsolicitedly transmits on management link 1710 a receipt with (i) a clear-text marker indicating at least the event and (ii) a payload including selected fields such as chiplet identifier, topology locator, lifecycle counter, time value, measurement digest, and result, together with a cryptographic authenticator bound to a context value maintained in key boundary 1780. The marker makes the receipt externally observable at a protocol boundary; the payload may be authenticated and/or encrypted. In some embodiments, management controller 1720 conditions enablement on a validating receipt. A ledger 1740 aggregates receipt hashes as leaves 1741 in a Merkle tree 1742 and anchors 1744 commit roots; a verification interface 1750 furnishes authenticator attestations and inclusion proofs to an external verifier 1760.

### BACKGROUND OF THE INVENTIONS

### 1. Field of the Inventions

The invention relates to die-to-die interconnects and in-package manageability for multi-die (chiplet-based) electronic systems. It concerns protocol-level receipt messages, serialized as a Type-Length-Value (TLV) or equivalent, that are unsolicited and mandatory at defined chiplet lifecycle state transitions (including discovery, enumeration, authentication, enablement, quiescence, reset, and retirement). Each receipt includes an externally observable marker on the management transport and a cryptographically bound payload, enabling black-box conformance testing, attestation, and auditability across heterogeneous chiplets. Although examples reference UCIe-class packages, the mechanisms apply to any in-package management transport (sideband or encapsulated mainband) coordinating lifecycle control in multi-die systems.

### 2. Description of the Related Art

Semiconductor manufacturers increasingly assemble multi-die (“chiplet”) packages to improve yield, cost, heterogeneous integration, and time-to-market. In such systems, dies sourced from different vendors must interoperate across a die-to-die interconnect and an in-package management network 1710 that coordinates discovery, provisioning, authentication, enablement, quiescence, reset, retirement, debug, and audit for multiple chiplets 1712a-1712n under the supervision of a management director 1720. While functional datapaths have matured, the manageability plane remains fragmented and vendor-specific.

Conventional approaches rely on request/response attestation initiated by a host, on local or BMC-resident event logs, and on ad-hoc telemetry or debug streams. These mechanisms are typically optional, invisible on the wire, and not emitted precisely when a chiplet crosses a defined lifecycle boundary. As a result, integrators and auditors cannot verify behavior by black-box observation, certification bodies cannot define objective pass/fail criteria tied to on-link artifacts, and platforms may progress to enabled operation without externally verifiable evidence of required prerequisites.

The absence of a lifecycle state transition (LST) receipt creates several recurring problems. First, there is no unsolicited on-wire artifact when a chiplet moves, for example, from discovery to enumeration or from authentication to enablement; proving correct sequencing requires polling, privileged access, or vendor cooperation. Second, even where status messages exist, they are often encapsulated or fully encrypted without a stable, parseable outer marker, preventing a passive tool from confirming that a particular transition occurred at a particular time. Third, manageability features are frequently negotiated as optional “capabilities,” allowing otherwise compliant devices to ship without emitting any consistent record of transitions, which undermines cross-vendor interoperability. Fourth, timing is ambiguous: existing logs seldom bind a deterministic window between an observed transition and whatever entry purports to record it, leaving reordering and replay hard to exclude. Fifth, linkage to policy and topology changes is weak because long-lived keys and counters are not consistently used to bind receipts to epochs; stale evidence can therefore be misapplied.

Although transparency logs and Merkle anchoring are known in other domains, device-lifecycle evidence inside a package is rarely summarized into tamper-evident roots with compact inclusion proofs. Operators are also reluctant to expose detailed measurements on the wire, and there is no standard separation between a minimal, externally observable marker and a protected payload. Without a normative, on-wire mechanism that is both observable and privacy-preserving, certification, forensics, and supply-chain audits remain slow, bespoke, and difficult to reproduce.

The embodiments disclosed below address these deficiencies by introducing an unsolicited manageability receipt that is emitted at defined LST boundaries on the management network 1710, is externally observable through a stable clear-text marker, binds a canonical payload under epoch-scoped cryptography within a key boundary 1780, may be summarized by a ledger service 1740 with anchors 1744 and proofs via a verification interface 1750, and, where appropriate, conditions enablement decisions at the director 1720 on the presence and validation of such receipts.

### SUMMARY OF THE INVENTIONS

The invention provides a manageability receipt mechanism for multi-die packages in which a management director 1720 (maintaining a lifecycle state machine 1722) causes a standardized receipt to be emitted on the management network 1710 whenever a chiplet 1712a-1712n crosses a defined lifecycle state transition. Emission is unsolicited: the system does not wait for a poll or request, but generates the receipt as a matter of course at the moment the transition is detected. Each receipt appears on the link with a stable, clear-text marker that remains externally parseable and identifies the message as a receipt, the protocol version, the event corresponding to the transition, and the current epoch. Behind the marker sits a canonical payload, optionally protected with authenticated encryption, that records in predetermined order a topology locator for the chiplet, a chiplet identifier, a digest of relevant measurements, a monotonic lifecycle counter that increments exactly once per transition, the epoch identifier, a result code, a time value, and a cryptographic authenticator computed under a key scoped to the epoch within the key boundary 1780.

Temporal coupling is integral to the mechanism. The director 1720 transmits the receipt within a bounded interval from detection of the transition and, where applicable, before enabling the next operational state. Entry into an enabled state is conditioned on the presence and validation of the receipt for the authenticate-to-enable transition; thus receipts are not merely logs but part of the operational semantics of the system. For durable audit, the ledger service 1740 commits compact summaries of receipts as leaves of a Merkle tree 1742, and anchors 1744 are published periodically to commit roots; a verification interface 1750 can later provide inclusion proofs and tag attestations to an external verifier 1760 without exposing secrets. The approach is transport-agnostic (sideband or mainband-encapsulated) and privacy-preserving: only the minimal marker is visible on the wire, while sensitive details remain in the protected payload. In practical effect, lifecycle transitions become observable, time-bound, policy-bound, and gate-enforced, enabling black-box conformance, interoperable auditing, and reproducible certification across heterogeneous chiplets.

Other features, aspects and advantages of the present inventions will become apparent from the following discussion and detailed description.

### BRIEF DESCRIPTION OF THE DRAWINGS

FIG. 1 schematically shows a multi-die package in which a management network 1710 interconnects representative chiplets 1712a-1712n and a management director 1720. The director embodies a lifecycle state machine 1722, a receipt engine 1730, and a key boundary 1780; downstream, a ledger service 1740 maintains a Merkle tree 1742, an anchor 1744 is published periodically as a commitment of the root, and a verification interface 1750 provides attestations and proofs to an external verifier 1760.

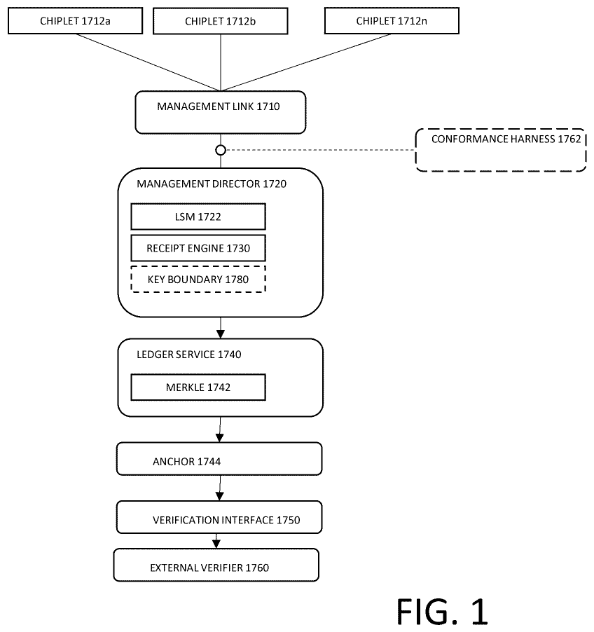

FIG. 2 presents the lifecycle state machine with states including discovery, enumeration, authentication, enablement, reset, quiescence, and retirement. Directed edges identify the lifecycle state transitions at which unsolicited receipts are emitted, and a per-chiplet monotonic lifecycle counter increments exactly once per transition.

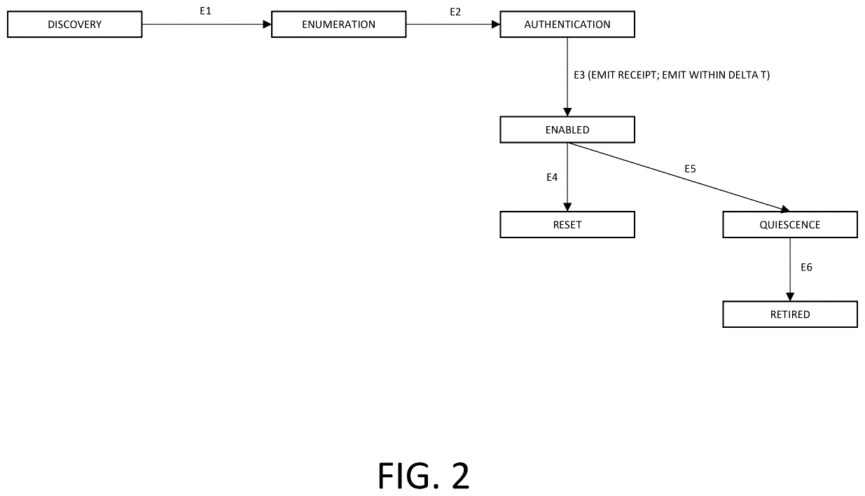

FIG. 3 depicts the wire format of the manageability receipt. A clear-text marker carries a reserved message type, a protocol version, an event code, and an epoch identifier; a canonical payload—optionally protected with authenticated encryption—records in predetermined order version and event, a topology locator, a chiplet identifier, a measurement digest, a lifecycle counter, the epoch identifier, a result code, a time value, and a cryptographic tag computed under an epoch-scoped key within 1780.

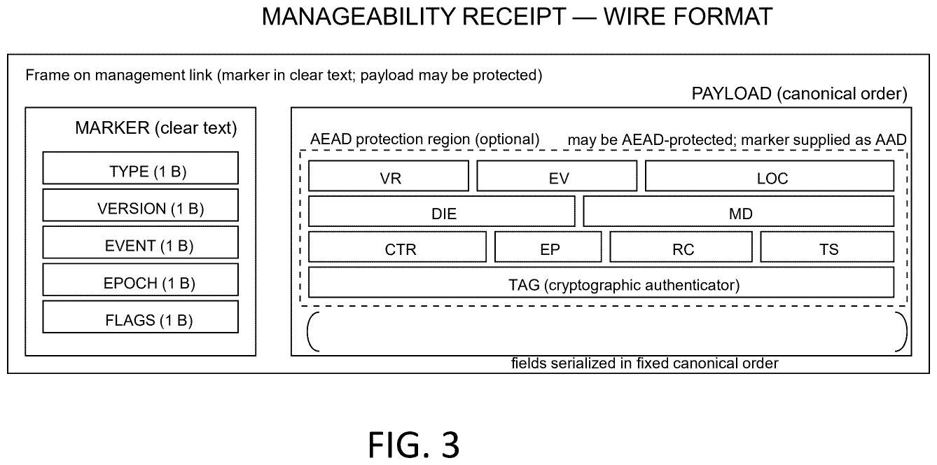

FIG. 4 provides a sequence view for a representative bring-up segment encompassing discovery, authentication, and enablement. Receipts appear on 1710 within a bounded interval from detection of each transition; entry to enablement is conditioned on the presence and validation of the authenticate-to-enable receipt; and 1740 appends a leaf, 1744 commits a root, and 1750 returns an inclusion proof to 1760.

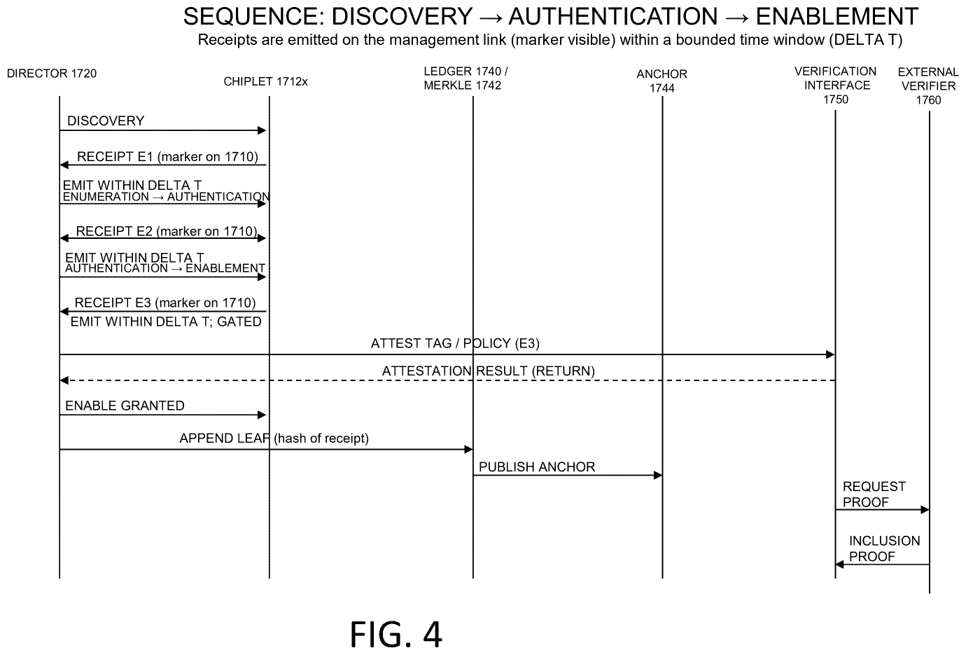

FIG. 5 illustrates the ledger model. Individual receipts contribute leaves 1741 to the Merkle tree 1742; the root for a period forms an anchor 1744. An inclusion path allows a verifier to demonstrate that a specific receipt is covered by the anchored root without revealing unrelated entries.

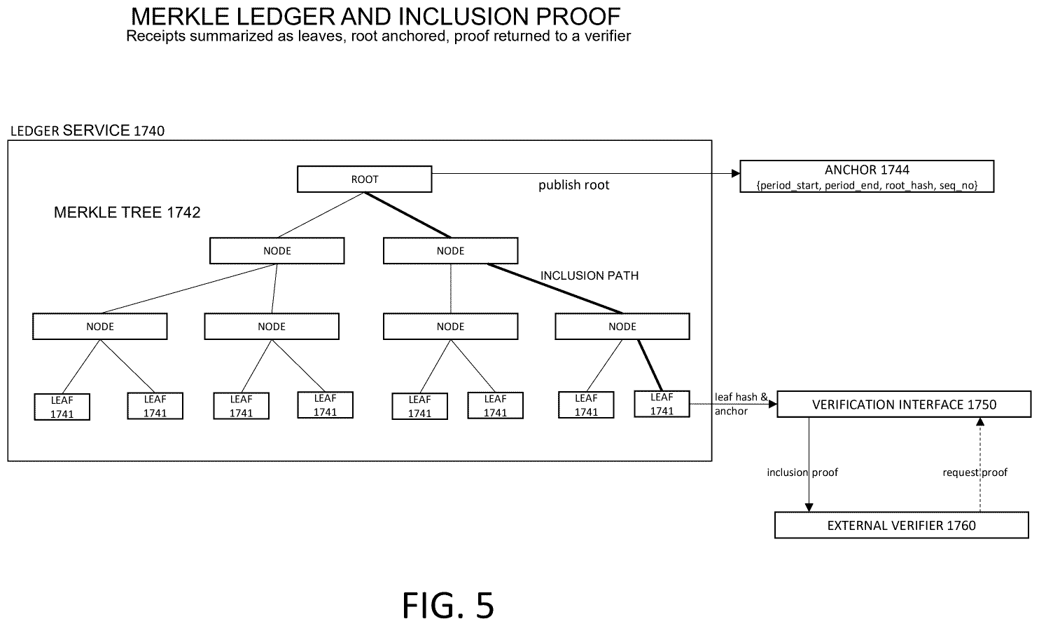

FIG. 6 depicts a conformance topology. A harness 1762 drives scripted transitions while a passive tap captures traffic on 1710. Pass/fail criteria include presence of a receipt at each defined transition, conformance of field structure and order, monotonicity of the lifecycle counter, validation of the tag for the epoch, adherence to the temporal bound, and availability of an inclusion proof via 1750.

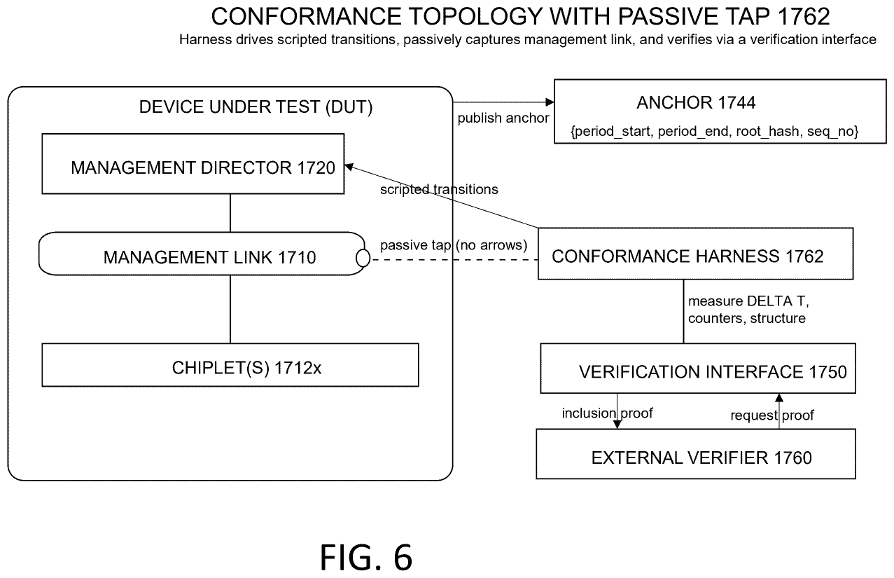

FIG. 7 presents a forward-secure signature variant. Receipts carry a forward-secure signature in place of or in addition to a MAC; signatures form a chain across epochs; the verification interface 1750 verifies the signature/chain using the anchored chain heads; the director 1720 uses the result to gate enablement; and anchors 1744 bind chain heads for durable audit.

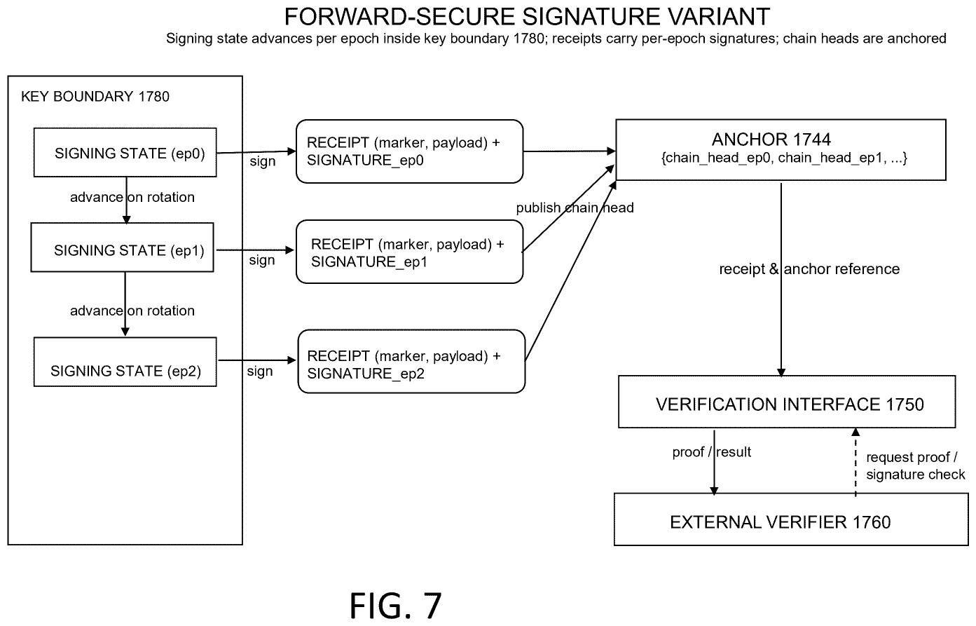

While the inventions will be described in connection with the preferred embodiments, it will be understood that the scope of protection is not intended to limit the inventions to those embodiments. On the contrary, the scope of protection is intended to cover all alternatives, modifications, and equivalents as may be included within the spirit and scope of the inventions as defined by the appended claims.

### DETAILED DESCRIPTION OF THE INVENTION

As will be appreciated by those skilled in the art, aspects of the present inventions may be embodied in various forms, including an entirely hardware implementation, an entirely software implementation (e.g. firmware, resident software, micro-code, etc.), or a combination of software and hardware elements. All such aspects may generally be referred to herein as a “circuit,” “module,” or “system.” Furthermore, aspects of the present inventions may take the form of a computer program product embodied in one or more computer-readable media having computer-readable program code instructions stored thereon.

Any combination of computer-readable media may be utilized to implement the inventions. A computer-readable medium may be a computer-readable storage medium or a computer-readable signal medium. A computer-readable storage medium may be, for example, but not limited to, an electronic, magnetic, optical, electromagnetic, infrared, or semiconductor system, apparatus, or device, or any suitable combination of the foregoing. Specific examples of storage media include, but are not limited to: an electrical connection having one or more wires; a portable diskette; a hard disk; a random access memory (RAM); a read-only memory (ROM); an erasable programmable read-only memory (EPROM or Flash memory); an optical fiber; a portable compact disc read-only memory (CD-ROM); an optical storage device; or a magnetic storage device. In the context of the present inventions, a computer-readable storage medium is any tangible medium that can contain or store program instructions for use by an instruction execution system, apparatus, or device.

A computer-readable signal medium may include a propagated data signal with computer-readable program code embodied therein (for example, in baseband or as part of a carrier wave). Such a propagated signal may take any of a variety of forms, including but not limited to electromagnetic or optical signals, or any suitable combination thereof. A computer-readable signal medium may be any computer-readable medium that is not a storage medium, and that can communicate, propagate, or transport program instructions for use by an instruction execution system, apparatus, or device.

Program code embodied on a computer-readable medium may be transmitted using any appropriate transmission medium, including but not limited to wireless communication, wireline communication, optical fiber cable, radio frequency (RF), or any suitable combination of these.

Computer program code for carrying out operations of aspects of the present inventions may be written in any combination of one or more programming languages. Examples include object-oriented programming languages (for example, Java®, Smalltalk, or C++), as well as conventional procedural programming languages (for example, C or similar languages). The program code may execute entirely on a single computer (e.g. the encoder or the decoder), partly on one computer and partly on another (e.g. a client-server or distributed environment), or entirely on a remote computer or server. In the latter scenario, the remote computer may be connected to the local system through any type of network, including a local area network (LAN), a wide area network (WAN), or the Internet (via an Internet Service Provider or other network connection).

Aspects of the present inventions are described below with reference to flowchart illustrations and block diagrams in the accompanying figures, which depict various method, system, and computer program product embodiments. It will be understood that each block or step shown in these diagrams, as well as combinations of blocks, may be implemented by computer program instructions. These program instructions may be provided to a processor of a general purpose computer, special purpose computer, or other programmable data processing apparatus to cause the processor to execute the instructions, thereby creating a machine that implements the functions/acts specified in the flowchart or block diagram block(s).

These computer program instructions may also be stored in a computer-readable storage medium that can direct a computer or other programmable data processing apparatus to function in a particular manner, such that the instructions stored in the medium produce an article of manufacture including instruction means that implement the functions/acts specified in the flowchart or block diagram. The computer program instructions may further be loaded onto a computer or other programmable apparatus to cause a series of operational steps to be performed on the device to produce a computer-implemented process. In this manner, the instructions executing on the computer or other programmable apparatus provide processes for implementing the functions/acts specified in the flowchart and/or block diagram blocks.

In representative embodiments, a multi-die package includes a management network 1710 interconnecting heterogeneous chiplets 1712a-1712n and a management director 1720. The director maintains a lifecycle state machine 1722 for each chiplet, invokes a receipt engine 1730 whenever a defined lifecycle state transition is detected, derives and protects per-epoch keys within a key boundary 1780, commits compact summaries of receipts through a ledger service 1740 into a Merkle tree 1742, publishes anchors 1744 at selected intervals, and exposes a verification interface 1750 through which an external verifier 1760 can obtain tag attestations and inclusion proofs.

The lifecycle state machine 1722 presents, at minimum, discovery, enumeration, authentication, enablement, quiescence, reset, and retirement states. The director treats the directed edges between these states as lifecycle state transitions for which emission of a manageability receipt is mandatory. For each chiplet (or functional partition thereof), the director maintains a monotonic lifecycle counter that increments exactly once at the instant an eligible transition is detected; the counter does not regress and is used to detect replay and to preserve ordering across retries and link disturbances.

Upon detecting a transition, the receipt engine 1730 constructs a manageability receipt that is serialized for transmission on 1710 as a message comprising a clear-text marker followed by a canonical payload. The marker remains externally parseable and identifies the message as a receipt, carries a protocol version, encodes the event corresponding to the transition, and includes an epoch identifier that binds the receipt to the active epoch. The payload records, in predetermined order, a topology locator for the chiplet, a chiplet identifier, a digest of measurements relevant to trust (for example firmware or fuse configuration), the current value of the monotonic lifecycle counter, the epoch identifier (optionally repeated), a result code indicating success or failure class, a time value coupled to the transition, and a cryptographic authenticator computed over the payload fields using a per-epoch key held within 1780. Implementations may protect the payload with authenticated encryption while keeping the marker in clear text; when this is done, the marker is included as associated data so that any alteration of the visible marker invalidates the protected payload.

Temporal coupling is enforced by emitting the receipt within a bounded interval from detection of the transition and, where applicable, before enabling the next operational state. Enablement is conditioned on the presence and validation of the receipt corresponding to the authenticate-to-enable transition; the director 1720 refuses entry into the enabled state until the cryptographic authenticator validates for the current epoch and any applicable policy predicates over the measurement digest are satisfied. In this way, the receipts form part of the operational semantics rather than an advisory log.

The management network 1710 may be realized as a dedicated sideband path or as a management channel encapsulated within a primary interconnect. In dual-path configurations the director emits the receipt on at least one path and sets a path indicator in the marker so that passive tools can locate the traffic. Link-layer encryption or integrity protection on the transport does not obviate on-wire observability: the marker remains visible, and where the transport accepts associated data the marker is duplicated into that channel so that stripping or tunneling attempts are detectable by mismatched integrity checks.

The topology locator supports both horizontal and vertical integration. In a partitioned die, the locator includes a partition identifier so that receipts from concurrent functional domains remain distinguishable; emissions are serialized per partition to preserve a well-defined counter. In stacked assemblies, the locator may encode a three-dimensional coordinate or reticle position so that auditors can disambiguate among vertically aligned chiplets and reconstruct package geometry during analysis.

To provide durable audit without exposing sensitive data, the ledger service 1740 computes a compact hash over canonical payload fields together with the cryptographic authenticator and appends the hash as a leaf 1741 to the Merkle tree 1742. At defined intervals—or after a threshold number of receipts—the root of 1742 is published as an anchor 1744 containing at least a period identifier, a sequence number, and the root hash; anchors may be notarized or timestamped according to deployment policy. The verification interface 1750 later returns, for any given receipt, an inclusion proof from the corresponding leaf to the anchored root together with an attestation that the cryptographic authenticator is valid for the indicated epoch. Because only hashes appear in the ledger, measurement confidentiality is preserved while provenance remains verifiable.

Failure handling preserves both observability and correctness. If congestion would cause a full payload to miss the bounded interval, the director emits a marker-only pre-receipt immediately and follows with the complete payload as soon as the link permits; the two fragments share a nonce so they are unambiguously correlated. Retries set an error indication but do not advance the lifecycle counter. If power loss or reset occurs mid-transition, the director emits a diagnostic transition upon recovery, increments the counter, and maintains the enable gate closed until a valid receipt is observed for the normal path. When epoch rotation is triggered by time expiry, topology change, or policy update during a transition, the completed receipt carries the new epoch identifier and is authenticated under the new epoch key, preventing cross-epoch replay. If the lifecycle counter reaches its configured width, the director records a counter-wrap condition, requires a quiescence-to-retire path, and only then restarts discovery with a reset counter, avoiding ambiguous ordering across long service lives.

Conformance can be established by passive capture of 1710 while a harness 1762 drives scripted transitions. A conforming implementation produces, for each defined transition, a receipt whose marker arrives within the configured interval, whose payload (where visible) adheres to the canonical order, whose lifecycle counter increments exactly once, whose cryptographic authenticator validates for the epoch via 1750, and for which an inclusion proof is available under the current anchor 1744. The same properties allow third parties to detect practice or non-practice by black-box observation without privileged access or cooperation from the vendor.

The described embodiments are transport- and vendor-neutral. Field sizes, epoch cadence, cryptographic primitives, and encoding details may vary according to product constraints, provided that the essential properties are maintained: unsolicited emission at defined lifecycle transitions, a stable clear-text marker on the management link, a canonical and cryptographically bound payload with a monotonic lifecycle counter and epoch binding, temporal coupling of emission to the transition within a bounded interval, enable-gated entry to enabled state, and optional anchoring with independently verifiable inclusion proofs.

### Example Embodiments

In a first embodiment, the package exposes a sideband 1710 that carries a compact, fixed-width marker followed by a canonical payload protected with authenticated encryption. The management director 1720 implements the lifecycle state machine 1722 and invokes the receipt engine 1730 whenever discovery advances to enumeration, enumeration advances to authentication, or authentication advances to enablement. For each of these transitions, a receipt is emitted within a bounded interval, the marker arrives in clear text on 1710, and the payload records a topology locator, a chiplet identifier, a digest of configuration measurements, a monotonic lifecycle counter, an epoch identifier, a result code, a time value, and a cryptographic authenticator computed under a per-epoch key maintained inside the key boundary 1780. Enablement is withheld until the authenticate-to-enable receipt validates; once validation succeeds, the director 1720 permits the state machine to enter the enabled state and causes the ledger service 1740 to commit a leaf to the Merkle tree 1742, with the anchor 1744 incorporating the root into the next anchor.

In a second embodiment, manageability traffic is encapsulated on a main data fabric rather than a dedicated sideband. The marker remains visible on the encapsulated hop so that a passive capture can confirm the presence of receipts on the wire, while the payload is bound as associated data to any link-layer protection. A receiver that observes a payload whose bound marker differs from the on-wire marker treats the receipt as invalid and signals an error through the verification interface 1750; the enable gate remains closed until a fresh receipt validates under the current epoch.

In a third embodiment, the director is deployed in a redundant pair for high availability. A primary instance handles normal operation; a warm-standby instance ingests anchors, mirrors the epoch state within 1780, and tracks counters by observing receipts. During a takeover, the standby emits a single takeover diagnostic and refuses to raise the enable gate until it has re-established the current epoch and confirmed continuity of the Merkle sequence produced by 1740 and 1744. Anchors straddling the switchover form a contiguous sequence that the verification interface 1750 can prove with inclusion paths to an external verifier 1760.

In a fourth embodiment, a single chiplet contains multiple functional partitions that may transition independently. The topology locator encodes a partition identifier so that receipts from concurrent domains remain distinguishable. Emissions are serialized per partition, the lifecycle counter advances exactly once for each partition-local transition, and a verifier reconstructs interleaved traffic by grouping on the partition identifier in combination with the counter and epoch fields. The enable gate applies per partition, permitting, for example, I/O to be enabled while a compute partition awaits a validating receipt.

In a fifth embodiment tuned for automotive safety, the temporal bound is tightened for bring-up transitions, and anchors are produced at a higher cadence so that periodic proofs can be attached to safety cases. The clear-text marker remains minimal to avoid leaking proprietary configuration data, while the payload's digest allows an auditor, via 1750, to confirm that the firmware image and fuse state matched a certified allow-list at the moment enablement occurred. The same receipts support over-the-air updates by requiring a fresh authenticate-to-enable receipt in a new epoch before the vehicle accepts a post-update enable state.

In a sixth embodiment for data-center packages, anchors and inclusion proofs are integrated with a registry operated by a fleet controller. The ledger service 1740 commits per-transition leaves, the anchor 1744 posts roots to the controller at fixed intervals, and the verification interface 1750 returns compact proofs for any receipt identifier presented by operations tooling. Because the marker is observable on 1710, a black-box probe in a lab can reproduce the controller's result with only packet captures and the registry's anchors, without privileged access to device internals.

In a seventh embodiment, forward-secure signatures replace, or are layered with, message authentication codes for the cryptographic authenticator. A forward-secure key inside 1780 advances irreversibly at epoch rotation, and receipts in each epoch are signed such that compromise of a future state does not permit forgery of signatures in prior epochs. Anchors bind the heads of signature chains so that long-term non-repudiation is available without revealing underlying measurements. The verification interface 1750 exposes signature verification as an alternative to tag attestation.

In an eighth embodiment addressing transient congestion, the director emits a marker-only pre-receipt immediately upon detecting a transition when bandwidth pressure would otherwise push a full payload beyond the temporal bound. The pre-receipt carries a nonce, remains visible on 1710, and is followed by the full payload as soon as the link clears; the two fragments share the nonce so that a verifier can correlate them. The enable gate does not rise on the pre-receipt alone; it rises only after a validating payload arrives within the allowed window.

In a ninth embodiment, epoch rotation is triggered by a topology change such as the hot-insertion of a replacement chiplet. The director advances the epoch identifier, derives a new per-epoch key inside 1780, and authenticates subsequent receipts under the new epoch. A receipt in flight during the rotation carries the new epoch and is validated against the new key; if a pre-receipt was already emitted, the completing payload reuses the pre-receipt's nonce so that correlation remains intact across the boundary. The verification interface 1750 rejects any attempt to validate a stale receipt under the new epoch.

In a tenth embodiment, the verification interface 1750 is implemented as a small, auditable service that accepts the canonical fields of a captured receipt and returns two results: first, an attestation that the cryptographic authenticator verifies for the epoch and fields presented; second, an inclusion proof from the relevant leaf to the most recent anchor supplied by 1744, together with the anchor artifact necessary for independent checking. Where deployments require private audit, the interface restricts access to proofs while leaving the on-wire marker unchanged so that conformance and infringement analysis remain feasible by passive capture.

### Alternative Embodiments

The mechanism admits numerous variations without departing from its core properties-unsolicited emission at defined lifecycle boundaries, an externally parseable marker on the management link, a canonical cryptographically bound payload, temporal coupling to the transition, enable-gated control where applicable, and optional anchoring with independently verifiable proofs.

In some embodiments the management path is a dedicated sideband 1710 with fixed-width framing; in others, manageability is encapsulated over a primary fabric while the marker remains visible and is bound as associated data so that stripping is detectable. Dual-path devices may prefer the sideband under normal conditions and fall back to encapsulation during maintenance, with the path indicated in the marker and logged by the director 1720. Virtualized directors may forward receipts through a hypervisor that preserves marker visibility and delegates payload verification to a secure service.

The payload protection can be realized with authenticated encryption or with an integrity-only scheme when confidentiality is unnecessary. The authenticator may be a message authentication code computed under a per-epoch key inside the key boundary 1780, or a forward-secure signature generated by a state-advancing key such that later compromise does not permit forgery of earlier receipts. Truncation lengths, cipher suites, and key-derivation functions vary by profile; per-epoch keys may be derived from a root sealed in a discrete secure element, a CPU enclave, or a FIPS-validated module. Threshold protection is also possible: multiple controllers co-sign validation before the enable gate is lifted.

Topology and identity fields admit alternative encodings. The topology locator may be a slot/stack index, a three-dimensional coordinate, or a reticle coordinate for stacked assemblies; the chiplet identifier may be an ECID, an EUID, or an attested alias that is stable only within an epoch for privacy. The measurement component can be a digest over firmware and fuse state, a digest of a signed manifest, or a policy token issued by an enterprise controller; in each case, the digest binds the receipt to the configuration observed at the transition without disclosing raw values on the wire.

Temporal behavior can be tuned. The bounded interval may be uniform across transitions or tightened for bring-up edges while relaxed for service edges. When congestion threatens to violate the bound, implementations may emit a marker-only pre-receipt followed by the full payload, or fragment the payload across short frames that collectively complete within the window; fragments share a nonce and are rejected if recombination fails integrity checks. Epoch rotation can be driven by wall-clock time, tick count, topology changes, or policy updates, with grace rules that finish in-flight transitions under the new epoch and reject cross-epoch replay at the verification interface 1750.

Gating semantics vary with safety goals. Some devices gate only the authenticate-to-enable edge, while others additionally gate reset or quiescence exits if policy requires attested state. In safety-critical profiles, a redundant pair of directors verifies each other's anchors 1744 and refuses enablement during takeover unless anchor continuity is proven. For bring-up diagnostics, a degraded mode may permit enablement under a software-backed key with explicit flags that appear in the result code and in anchors, while production profiles forbid degraded enablement.

Anchoring and proof publication are adaptable. A ledger service 1740 can operate locally with periodic root publication to a regulator-accessible registry, or write roots to a fleet controller that returns compact inclusion proofs on demand. Public anchors enable third-party verification; private anchors restrict access to proofs while preserving on-wire observability through the marker. Where anchors are unavailable (for example, in tightly constrained devices), verifiers may rely solely on live captures and tag attestations; anchoring can be enabled later without altering marker structure.

Conformance tooling can be minimal or rich. A lightweight harness 1762 may drive only bring-up edges and measure the marker's arrival time; fuller suites decode canonical ordering, validate counters and epochs, and request inclusion proofs for representative receipts. Profiles tailor acceptance windows, degraded-mode allowances, field padding, and proof latency, but all require that receipts appear unsolicited at the defined edges and that their markers be observable on the link.

Finally, deployment models range from a single-package system to multi-package assemblies in which receipts traverse an inter-package fabric before reaching the director 1720. In such systems the marker remains intact end-to-end, the payload's authenticator verifies at 1750, and anchors 1744 bind leaves from multiple packages into a unified audit stream, enabling supply-chain-level certification without vendor-specific probes.

### Prior Art

The following discussion of related work is provided for context and to clarify distinctions. It is not an admission that any item discussed is prior art under any jurisdiction or that it is material to patentability.

Device attestation protocols in common use rely on a request/response (“pull-based”) model in which a host issues a measurement or attestation request and a device returns evidence on demand. These exchanges do not require unsolicited emission precisely when a chiplet crosses a lifecycle boundary, are not coupled to enablement decisions, and do not prescribe a stable, externally parseable marker on an in-package management link such as 1710. In general, they are silent on bounded timing between detection of a lifecycle event and the availability of any evidence on the wire, and they do not define epoch-scoped authenticators or per-chiplet lifecycle counters as a normative part of the transport.

Platform and firmware logging mechanisms (for example, measured-boot event logs maintained by a board controller or host) record boot-time or configuration events in local storage. Such logs are not designed to be observable on the management link 1710 and typically require privileged access to retrieve. They describe platform state rather than per-chiplet lifecycle transitions, do not mandate emission at discovery, authentication, enablement, reset, quiescence, or retirement, and are not tied to gating of state changes. Because they lack a clear, on-wire marker and a bounded emission window, they do not support black-box conformance by passive capture.

Out-of-band management frameworks and server/event logging interfaces provide useful operational telemetry but generally focus on chassis- or board-level management rather than in-package, die-to-die manageability. Where event streams exist, they are optional, vendor-specific, and not defined to be emitted unsolicited at lifecycle state transitions of individual chiplets 1712a-1712n. They also lack the enable-gate semantics by which a management director 1720 refuses entry into an enabled state absent validated lifecycle evidence.

In-band network telemetry systems annotate data traffic with hop-by-hop measurements for performance analysis. These mechanisms operate in the network dataplane, not in an in-package manageability plane, and they carry transient performance metadata rather than lifecycle receipts. They neither prescribe a canonical payload recording chiplet identity, topology locator, lifecycle counter, time value, and epoch-scoped authenticator, nor require emission at the specific lifecycle edges enforced by a director 1720 and lifecycle state machine 1722.

Debug transports for multi-die systems provide plumbing for test and trace across chiplets but do not define the semantics of lifecycle evidence. Where they encapsulate debug messages over an inter-die fabric, they do not require a reserved receipt type with a clear-text marker, do not mandate a canonical, cryptographically bound payload, and do not couple emission to a bounded interval relative to a detected lifecycle state transition.

Transparency-log systems and Merkle-tree anchoring are known in public-key infrastructure and software supply-chain contexts. They provide tamper-evident inclusion proofs for published items, but they do not teach applying such anchoring to in-package lifecycle receipts, nor do they combine anchoring with unsolicited, on-wire emission at lifecycle boundaries, epoch-scoped authenticators, or enable-gate enforcement in a multi-die manageability plane.

Finally, vendor-specific sideband messages and local audit trails exist in some products, but these are typically optional, lack a standardized on-wire marker that passive tools can recognize, are not emitted deterministically at the defined lifecycle edges, and are not integrated with a gate that conditions enablement on validated evidence. They also do not prescribe the use of a per-chiplet monotonic lifecycle counter and an epoch identifier that appears both in a visible marker and in a protected payload.

By contrast, the present disclosure specifies that (i) at each defined lifecycle state transition, the system emits-without receiving a request-a manageability receipt on 1710 with a stable, clear-text marker; (ii) the receipt's payload follows a canonical order and is bound by an authenticator computed under a per-epoch key retained within a key boundary 1780; (iii) emission is temporally coupled to detection of the transition within a bounded interval and, where applicable, precedes enablement; (iv) a gate at 1720 refuses entry into the enabled state unless the authenticate-to-enable receipt exists and validates; and (v) receipts may be summarized by a ledger service 1740 as leaves 1741 of a Merkle tree 1742 with anchors 1744 and proofs exposed by a verification interface 1750 to an external verifier 1760. Taken together, these features establish externally observable, policy- and time-bound lifecycle evidence that existing approaches neither require nor provide.

### Advantages Over Prior Art

The mechanism makes lifecycle evidence externally verifiable by emitting an unsolicited manageability receipt precisely at each lifecycle boundary on the management link 1710. Prior approaches are generally pull-based or confined to privileged logs, so a third party cannot observe transitions from outside the device.

A stable, clear-text marker on 1710 exposes only what is necessary to identify the event and epoch, while the sensitive details remain in the protected payload. Because the marker is always present on the wire, certification and field forensics are possible without keys or vendor-specific hooks; systems that encrypt or localize all evidence cannot support the same black-box audit.

Lifecycle evidence is tied to control: the management director 1720 refuses entry into the enabled state unless the authenticate-to-enable receipt exists and validates. In prior work, evidence is typically advisory and not a precondition for state progression. Here, the lifecycle state machine 1722 and the enable gate ensure that correct emission and validation are part of the operational semantics.

Temporal coupling is explicit. The first byte of the marker must arrive within a bounded interval after detection of the transition; logs that are written later or on a best-effort basis cannot guarantee this binding. Freshness and ordering are reinforced by a monotonic lifecycle counter in the payload and an epoch identifier tied to per-epoch keys held inside the key boundary 1780, which together prevent duplication, reordering, and cross-epoch replay.

Transport handling preserves observability even when link-layer protection is used. The marker remains visible on 1710 and, where supported, is bound as associated data so that stripping or tunneling attempts are detectable. Debug or telemetry streams in the literature do not mandate this binding and can be silently removed from view.

For durable audit, the ledger service 1740 summarizes receipts as leaves 1741 in a Merkle tree 1742, and an anchor 1744 commits period roots. This brings compact, third-party-checkable inclusion proofs to in-package lifecycle evidence; conventional device logs provide, at best, attestable snapshots rather than independently verifiable commitments.

Certification is straightforward. A lab can drive scripted transitions, capture markers on 1710, and obtain tag attestations and inclusion proofs from the verification interface 1750. Because the rules are normative and observable, multi-vendor deployments can be certified against the same pass/fail criteria. Reliance on internal logs or opaque management channels, by contrast, does not yield reproducible cross-vendor certification.

Finally, the design is portable across implementations while preserving the non-negotiable core: unsolicited on-wire receipts at defined transitions on 1710, a visible marker, a canonical cryptographically bound payload, bounded timing, enable-gated control at 1720, and optional anchoring via 1740/1742/1744 with verifications through 1750 to an external verifier 1760. This combination produces an externally provable lifecycle trail that existing approaches do not provide.

### Alternative Applications

Finally, the design is portable across implementations while preserving the non-negotiable core: unsolicited on-wire receipts at defined transitions on 1710, a visible marker, a canonical cryptographically bound payload, bounded timing, enable-gated control at 1720, and optional anchoring via 1740/1742/1744 with verifications through 1750 to an external verifier 1760. This combination produces an externally provable lifecycle trail that existing approaches do not provide.

In rack-scale systems, multi-device fabrics benefit in the same way. Memory-pooling or accelerator fabrics can surface receipts at enclosure boundaries so that a fleet controller, acting as 1720, refuses to map resources until authenticate-to-enable evidence validates. Because only a small marker is exposed on the wire, operators can certify behavior by capture while keeping configuration digests confined to the protected payload and verified through a service equivalent to the verification interface 1750.

Safety-critical deployments (automotive ECUs, avionics LRUs, medical devices) gain a time-bounded, auditable trail for over-the-air updates and maintenance. A domain controller in the role of 1720 can require a validating authenticate-to-enable receipt before energizing critical functions, and anchors maintained by a ledger service 1740 can be attached to safety cases as durable evidence. Where redundancy is mandated, dual directors cross-check anchors via 1744 and refuse enablement during takeover until continuity is proven.

Manufacturing and RMA workflows can use receipts to localize faults across assembly and test stages. During package test, burn-in, and final provisioning, emissions on 1710 create a tamper-evident chain from first discovery through enablement, so field failures can be correlated to the exact lifecycle point recorded in the anchors. Because leaves 1741 contain only compact hashes, yield analysis can run at scale without exposing design data, while the key boundary 1780 ensures that authenticators cannot be forged off-line.

Supply-chain assurance also benefits. Where chiplets originate from multiple vendors, a packaging house—using a minimal director 1720—can require receipts at each ingest and enable step, producing anchors 1744 that prove the path to a finished module. Downstream integrators can verify inclusion proofs without NDAs by querying a verifier equivalent to 1750, while still keeping manifests and fuse values private inside the payload.

In cloud and telecom infrastructure, receipts ease compliance and change-control. A platform controller in the role of 1720 can require fresh receipts in a new epoch whenever policy or topology changes, preventing stale enablement after drift. Operations teams can certify conformance by driving scripted transitions and capturing markers on 1710, then stapling verifier transcripts from 1750 to change tickets; this replaces fragile, vendor-specific screenshots with compact, machine-verifiable artifacts.

Finally, the mechanism generalizes to cross-package or inter-chassis scenarios. If lifecycle actions traverse an interconnect before reaching 1720, the marker can be preserved end-to-end while the payload's authenticator continues to verify at 1750. Anchors 1744 can then bind receipts from multiple packages into a unified audit stream through 1740, enabling fleet-level certification using the same black-box captures and proofs that apply in a single-package setting.

### Best Mode

The preferred implementation targets a UCIe-class multi-die package with a sideband management link 1710 and an optional mainband-encapsulated management path. A management director 1720 runs a lifecycle state machine 1722, calls a receipt engine 1730 on each defined lifecycle state transition, derives and holds per-epoch keys inside a key boundary 1780, commits compact receipt summaries through a ledger service 1740 into a Merkle tree 1742, publishes anchors via 1744, and exposes a verification interface 1750 to an external verifier 1760.

Lifecycle and timing. The director treats discovery->enumeration, enumeration->authentication, authentication->enablement, enablement->reset, enablement->quiescence, and quiescence->retirement as mandatory receipt points. Emission is unsolicited and time-bound: the preferred Delta t is <=25 ms for discovery/authentication/enablement and <=50 ms for reset/quiescence/retirement, measured from transition detection to arrival of the first byte of the marker on 1710. Entry to enablement is gated: the authenticate->enable receipt must exist and validate before the state machine advances.

On-wire marker. Each receipt begins with a fixed 5-byte clear-text marker on 1710: type (1 B)=0x5A (reserved ‘Receipt’ message type); ver (1 B)=0x01; ev (1 B)=lifecycle event code; ep (1 B)=epoch identifier; flags (1 B): bit0 presence=1, bit1 error, bit2 path (0=sideband, 1=mainband-encap), bit3 pre-receipt, bits4-7 reserved=0. When the management path is encapsulated, the same marker is duplicated into link-layer associated data so that stripping or tunneling attempts are detectable.

Canonical payload (preferred order and sizes). The payload follows the marker and is serialized as TLVs in this order, then protected with AEAD: (1) yr (1 B)=0x01 (payload version); (2) ev (1 B)=lifecycle event (repeated for integrity); (3) loc (6 B)=packed topology locator (x,y,z 10 bits each; partition_id 10 bits; 8 bits reserved); (4) die (16 B)=chiplet identifier (e.g., ECID/EUID); (5) md (32 B)=SHA-256 digest over a normalized manifest (firmware IDs, fuse/config hashes, policy tag); (6) ctr (4 B, big-endian)=monotonic lifecycle counter (per chiplet or partition); (7) ep (1 B)=epoch identifier (repeat); (8) rc (2 B)=result code (0=OK; non-zero=failure class); (9) ts (6 B)=director-relative tick at 1 ms resolution (48-bit); (10) tag (12 B)=cryptographic authenticator.

Cryptography and key schedule. The payload is protected with AES-256-GCM; the marker is supplied as AEAD associated data. The 96-bit IV is ep(8)∥sid(24)∥ seq(64), where sid is a server instance ID and seq is a per-epoch transmit counter (never reused). In addition, tag is HMAC-SHA-256 over the canonical payload fields (excluding tag), truncated to 96 bits for bandwidth efficiency. The per-epoch key k_ep is derived inside 1780 using HKDF-SHA-256: k_ep=HKDF(master_key, salt=master_salt, info=‘MRTL-epoch’∥package_ID∥policy_ID∥ep).

The verification interface 1750 attests AEAD integrity and HMAC validity without exposing keys.

Epoch policy. Epochs advance on time expiry (preferred default 10 minutes), topology change (chiplet add/remove or stack reindex), or policy update. The epoch identifier appears in both marker and payload; receipts from prior epochs are rejected. Rotation during a transition authenticates the completed receipt under the new epoch, preventing cross-epoch replay.

Pre-receipt and retries. If congestion risks exceeding Delta t, the director immediately emits a marker-only pre-receipt (flags.bit3=1) carrying an 8-byte nonce TLV directly after the 5-byte marker; the full payload follows as soon as the link permits and reuses the same nonce. The enable gate never lifts on a pre-receipt alone. Retries set the error flag and may set a retry-class rc; the lifecycle counter does not advance on retries.

Enable gate. For authenticate->enable, the director requires (i) a valid tag under the current ep and (ii) any configured policy predicate over md (e.g., manifest allow-list) before enabling. Other transitions may log failures without gating unless a profile demands stricter control.

Counter wrap. The lifecycle counter is 32-bit. Upon reaching 0xFFFFFFFF, the director records a counter-wrap condition, requires a quiesce->retire path, and only then allows a new discover sequence with counter reset. This avoids ambiguous ordering across long service lives.

Anchoring. The ledger service 1740 hashes canonical_payload∥tag as a receipt leaf and appends it to the Merkle tree 1742. Anchors are produced every 60 seconds or after 2048 receipts, whichever comes first. Each anchor contains {period_start, period_end, root_hash, seq_no} and is signed by the director; inclusion proofs are returned by 1750 for any receipt presented by an external verifier 1760.

Performance budgets. With AES/HMAC offload on a modest management MCU (>=400 MHz), receipt construction and authentication complete in <=10 microseconds; marker serialization is <50 microseconds at 1 Gb/s. End-to-end Delta t is dominated by state-machine notification and arbitration; the stated bounds are routinely met. Memory for counters is a few kilobytes for hundreds of chiplets; the Merkle working set fits in SRAM and flushes with each anchor.

Path selection. The sideband path is preferred for observability and independence from dataplane congestion; the marker's path bit indicates the actual carrier. If the sideband is unavailable, the mainband-encapsulated path is used with the marker still visible and duplicated into link associated data.

Result codes (illustrative). 0x0000 OK; 0x0001 auth_fail; 0x0002 tag_invalid; 0x0003 policy_expired; 0x0004 power_loss; 0x0005 dir_takeover; 0x0006 ctr_wrap; 0x0007 transport_fault. Any non-zero rc sets the marker's error flag.

Conformance profile. Bring-up uses the Delta t bounds above and permits pre-receipts; production tightens allowed retries and requires anchor availability within a fixed retrieval latency. In all profiles, the clear-text marker on 1710, canonical payload ordering, monotonic ctr, epoch binding, and the enable gate at 1720 are mandatory.

### INDUSTRIAL APPLICABILITY

The mechanism applies wherever multi-die packages must be brought up, authenticated, enabled, serviced, and retired under auditable control. In data-center compute (CPU/GPU/NPU/DPU packages), receipts on 1710 allow integrators to verify that each chiplet 1712a-1712n progressed through discovery, authentication, and enablement in order, while a management director 1720 enforces an enable gate so platforms do not energize unproven dies. Operations teams can attach anchors from a ledger service 1740 (rooted at 1742 and published via 1744) to change records, and auditors can request compact proofs through a verification interface 1750 queried by an external verifier 1760.

In networking ASICs and switches, the same receipts document hot-swap, reset, and quiescence events without vendor-specific probes; a lab can certify behavior by passive capture on 1710 alone. Automotive and other safety-critical electronics benefit during over-the-air updates: enablement of a safety function is conditioned by 1720 on a validating authenticate-to-enable receipt, while anchored proofs via 1740/1742/1744 provide durable evidence for safety cases without disclosing raw firmware or fuse values.

In telecom and edge deployments where mixed-vendor chiplets are common, conformance becomes reproducible: a buyer can specify receipt emission on 1710 with verification through 1750 as a procurement requirement, eliminating bespoke audits. Manufacturing, yield, and RMA flows use the receipts to localize failures across assembly and test; because only compact hashes and numerals are exposed on the wire, intellectual-property leakage is minimized while provenance remains verifiable.

For supply-chain assurance across multiple packaging houses, a minimal director 1720 can require receipts at each ingest and enable step, generating anchors 1744 that prove the path from chiplet receipt to finished module. Downstream integrators verify inclusion via 1750/1760, while keeping configuration digests inside the protected payload and off public links.

### OBJECTS OF THE INVENTIONS

To provide, at each defined lifecycle state transition, an unsolicited manageability receipt that is transmitted on the management link 1710 and is observable from outside the device boundary.

To ensure external observability by placing a stable, clear-text marker on 1710 while confining sensitive details to a cryptographically protected payload, enabling black-box verification without privileged access.

To bind provenance and context by recording, in a canonical payload order, at least a chiplet identifier, a topology locator, a monotonic lifecycle counter, an epoch identifier, a time value, and a cryptographic authenticator computed under a per-epoch key held within the key boundary 1780.

To couple evidence to control by configuring the management director 1720 to refuse entry into an enabled state unless a receipt corresponding to the authenticate-to-enable transition exists and validates.

To temporal-bind receipts to their triggering events by requiring emission within a bounded interval after transition detection and, where applicable, before enablement occurs on 1710.

To preserve privacy while maintaining auditability by keeping the marker minimal and including it as associated data when the payload is protected with authenticated encryption, without altering visibility on 1710.

To remain transport-agnostic by operating over a sideband link or an encapsulated path while preserving marker visibility; to support dual-path deployments with a path indicator, still observable on 1710.

To provide tamper-evident archival by committing compact summaries of receipts through a ledger service 1740 as leaves 1741 of a Merkle tree 1742, publishing anchors 1744, and enabling later verification through a verification interface 1750 queried by an external verifier 1760.

To enable reproducible conformance and certification using passive capture on 1710 together with verifications returned by 1750, defining objective pass/fail criteria independent of vendor-specific tooling.

To withstand failures without losing observability, including congestion (marker-only pre-receipts with nonce correlation), retries, epoch rotation, counter wrap handling, and director failover at 1720, while keeping gating semantics sound.

To promote interoperability across vendors by fixing a canonical field order, defining epoch and counter semantics, and constraining wire-visible behavior on 1710 that tools can rely on.

To minimize performance and area cost by using a compact marker, bounded payload sizes, and lightweight cryptographic operations appropriate for in-package controllers, without reducing visibility on 1710.

To make infringement detectability straightforward by ensuring that compliant implementations necessarily emit on-wire receipts with a visible marker on 1710 and verifiable context through 1750.

To remain extensible by accommodating forward-secure signatures as an alternative to message authentication codes, optional policy tokens in the payload, and future transport profiles without altering the observability contract on 1710.

To support partitioned and stacked devices by encoding partition identifiers and three-dimensional locators, maintaining per-partition lifecycle counters, and preserving order under concurrency as observed on 1710.

To allow profile tuning (bring-up versus production) for timing bounds, retry behavior, anchoring cadence, and proof availability, without weakening mandatory emissions or marker visibility on 1710.

To strengthen procurement and regulatory assurance by providing machine-verifiable artifacts-captures on 1710, attestations from 1750, and inclusion proofs bound to 1744 that buyers and regulators can evaluate without access to proprietary internals.

### SUMMARY OF ADVANTAGES

The mechanism makes lifecycle behavior externally verifiable on the wire by emitting an unsolicited receipt at each defined transition on 1710. A stable, clear-text marker enables black-box certification and field forensics without keys or vendor-specific probes, while sensitive details remain in the protected payload.

Lifecycle evidence is bound to control: the management director 1720 refuses entry into enabled operation until a validating authenticate-to-enable receipt exists. Receipts thus become part of system semantics rather than advisory logs, reducing the risk of energizing unproven chiplets 1712a-1712n.

Deterministic timing and ordering are enforced. Emission within a bounded interval, together with a monotonic counter and epoch binding under keys held inside 1780, ties each receipt to the precise moment of the underlying state change managed by 1722 and produced by 1730, and prevents replay or reordering.

The design is privacy-preserving yet auditable. Only minimal metadata are visible on 1710; the payload is integrity- (and optionally confidentiality-) protected and verified through 1750 without exposing secrets, so operators can satisfy audits without over-disclosure.

Provenance is tamper-evident and durable. Receipts are summarized as leaves 1741 in a Merkle tree 1742, anchors 1744 commit period roots, and compact inclusion proofs returned by 1750 allow an external verifier 1760 to confirm membership later, independent of device internals.

The approach is transport- and vendor-agnostic. It works over sideband or encapsulated paths while preserving marker visibility on 1710, enabling reproducible, cross-vendor conformance and simplifying procurement and interoperability testing.

It is failure-resilient. Pre-receipts, bounded retries, epoch-rotation rules, counter-wrap handling, and director failover keep behavior visible and the gate safe, so operational anomalies do not erase audit trails or weaken control at 1720.

Overhead is low and scalable. A compact marker, bounded payload, and lightweight cryptography within 1780 minimize latency and area while supporting large chiplet counts and high event rates.

Finally, practice is straightforward to detect. Because emission is mandatory and the marker is always present on 1710, compliant implementations are provable by passive capture, and design-around space that preserves conformance without practicing the core behavior is minimized.

### Exemplary Procedures (Pseudocode)

The following procedures illustrate one preferred realization of the manageability receipt flow across the management link 1710 using director 1720, receipt engine 1730, key boundary 1780, ledger service 1740 (Merkle 1742, anchors 1744), and verification interface 1750 queried by an external verifier 1760.

# Constants (profile-tunable)

| | |
|---|---|
| DELTA_T_EARLY_MS | = 25 # |

discovery/authentication/enablement

| | |
|---|---|
| DELTA_T_SERVICE_MS | = 50 # reset/quiescence/retirement |
| ANCHOR_PERIOD_MS | = 60000 |
| MAX_RETRIES | = 3 |

# Event codes (illustrative)

| | |
|---|---|
| EV_DISC_ENUM | = 0x01 |
| EV_ENUM_AUTH | = 0x02 |
| EV_AUTH_EN | = 0x03 |
| EV_EN_RESET | = 0x04 |
| EV_EN_QUIESCE | = 0x05 |

EV_QUIESCE_RET= 0x06

Director main loop (lifecycle detection at 1720/1722)

```
procedure DIRECTOR_MAIN( )
  init_epoch( )
  start_task(ANCHOR_TIMER)
  while true:
```

| | |
|---|---|
| evt | = LSM_WAIT_FOR_TRANSITION( ) # lifecycle state |

machine 1722

| | |
|---|---|
| t0 | = now_ms( ) |
| ctr | = |

```
INCR_LIFECYCLE_COUNTER(evt.chiplet_or_partition)
    # Choose timing bound for this class
    if evt.code in {EV_DISC_ENUM, EV_ENUM_AUTH,
EV_AUTH_EN}:
```

dt_bound = DELTA_T_EARLY_MS

else:

dt_bound = DELTA_T_SERVICE_MS

```
    EMIT_MANAGEABILITY_RECEIPT(evt, ctr, t0, dt_bound)
    # Gate only for authenticate−>enable
    if evt.code == EV_AUTH_EN:
```

if not

ENABLE_GATE_CHECK(evt.chiplet_or_partition, ctr):

```
  DENY_ENABLE(evt.chiplet_or_partition)
else
  ALLOW_ENABLE(evt.chiplet_or_partition)
end if
```

```
    end if
  end while
end procedure
```

Receipt emission path (marker+payload) at 1730 with AEAD and HMAC inside 1780

procedure EMIT_MANAGEABILITY_RECEIPT(evt, ctr, t0,
dt_bound)
# Build minimal clear-text marker

| | |
|---|---|
| marker.type | = 0x5A |
| marker.ver | = 0x01 |
| marker.ev | = evt.code |
| marker.ep | = CURRENT_EPOCH( ) |
| marker.flags | = presence=1 \| error=0 \| |

path=SELECT_PATH( ) | pre=0
# Canonical payload fields (ordered)

| | |
|---|---|
| pay.vr | = 0x01 |
| pay.ev | = evt.code |
| pay.loc | = TOPOLOGY_LOCATOR(evt.chiplet_or_partition) |

# slot/stack/3D/partition

| | |
|---|---|
| pay.die | = CHIPLET_ID(evt.chiplet_or_partition) |

# ECID/EUID

| | |
|---|---|
| pay.md | = MEASURE_MANIFEST(evt.chiplet_or_partition) |

# firmware/fuse/config digest

| | |
|---|---|
| pay.ctr | = ctr |
| pay.ep | = marker.ep |
| pay.rc | = 0x0000 |
| pay.ts | = DIRECTOR_TICK_1MS( ) |

# Protect payload (AEAD) and compute tag (HMAC) in key
boundary 1780

| | |
|---|---|
| k_ep | = KDF_EPOCH_KEY(marker.ep) |

# inside 1780

| | |
|---|---|
| iv | = BUILD_IV(marker.ep) |

# ep||sid||seq (96-bit, no reuse)

| | |
|---|---|
| aead | = AEAD_SEAL(k_ep, iv, serialize(pay without |

tag), AAD=serialize(marker))

| | |
|---|---|
| tag | = HMAC_TRUNC(k_ep, canonical_bytes(pay without |

tag), 96bits)
# Attach tag; form final frame

| | |
|---|---|
| pay.tag | = tag |
| frame | = serialize(marker) \|\| aead |

```
    # Timing: if congestion risks exceeding dt_bound, send
pre-receipt first
    if (now_ms( ) − t0) > (dt_bound / 2) and
LINK_BACKPRESSURE( ):
    nonce = RAND64( )
    PRE_RECEIPT(marker, nonce) #
marker.flags.pre=1, TLV nonce
    end if
    # Transmit on selected management path (sideband or
encapsulated)
    SEND_ON_MANAGEMENT_LINK(frame)
    # Ledger append (hash over canonical payload || tag)
    LEDGER_APPEND_HASH(hash(canonical_bytes(pay)))
    # Verify temporal bound
    if (now_ms( ) − t0) > dt_bound:
    LOG(“Timing violation: dt=” + (now_ms( )−t0) + “ms”)
    end if
end procedure
```

Enable-gate semantics at 1720 using 1750

```
procedure ENABLE_GATE_CHECK(chiplet_or_partition, ctr)
  receipt = LAST_RECEIPT_FOR(chiplet_or_partition,
EV_AUTH_EN, ctr)
  if receipt == NULL:
    return false
  end if
  # Attest cryptographic fields via verification
interface 1750
  ok_tag = VI_ATTEST_TAG(receipt.marker.ep,
receipt.payload_fields, receipt.tag)
  if not ok_tag:
    return false
  end if
  # Optional: policy check on measurement digest
  if POLICY_REQUIRES_MD( ):
    if not VI_CHECK_DIGEST(receipt.payload_fields.md):
      return false
    end if
  end if
  return true
end procedure
```

Ledger and anchor processes at 1740/1742/1744

procedure LEDGER_APPEND_HASH(leaf hash)

| | |
|---|---|
| MERKLE_ADD_LEAF(leaf_hash) | # updates working tree |

```
1742
end procedure
task ANCHOR_TIMER( )
  while true:
    sleep_ms(ANCHOR_PERIOD_MS)
```

| | |
|---|---|
| root | = MERKLE_ROOT( ) |
| seq | = NEXT_ANCHOR_SEQ( ) |
| anc | = {period_start, period_end, root_hash=root, |

seq_no=seq}

| | |
|---|---|
| PUBLISH_ANCHOR(anc) | # 1744 (e.g., registry |

or signed log)

| | |
|---|---|
| MERKLE_RESET_WINDOW( ) | # start new window |

end while
end task

Verification interface 1750

```
# Returns true/false; does not expose keys
function VI_ATTEST_TAG(epoch, canonical_payload, tag)
  k_ep = KDF_EPOCH_KEY(epoch) # inside 1780
or equivalent verifier enclave
  return HMAC_TRUNC(k_ep, canonical_payload, 96bits) ==
tag
end function
# Returns inclusion proof pi for a leaf (client verifies
against anchor root)
function VI_GET_INCLUSION_PROOF(leaf_hash)
  return MERKLE_PROOF(leaf_hash)
end function
# Optional policy check (e.g., manifest allow-list)
function VI_CHECK_DIGEST(md)
  return md in ALLOW_LIST( )
end function
```

Dual-path emission and marker binding on 1710

```
function SELECT_PATH( )
  if SIDEBAND_AVAILABLE( ):
    return PATH_SIDEBAND
  else:
    return PATH_ENCAPSULATED
  end if
end function
procedure SEND_ON_MANAGEMENT_LINK(frame)
  if SELECT_PATH( ) == PATH_SIDEBAND:
    LINK_SIDEBAND_SEND(frame) # marker
visible by design
  else
    # Encapsulated: duplicate marker into link-layer
AAD to prevent stripping
    LINK_ENCAP_SEND(frame, aad=extract_marker(frame))
  end if
end procedure
procedure PRE_RECEIPT(marker, nonce64)
  marker.flags.pre = 1
  pre_frame = serialize(marker) || TLV(nonce=nonce64)
  SEND_ON_MANAGEMENT_LINK(pre_frame)
end procedure
```

Epoch rotation and retries in 1720

```
procedure HANDLE_EPOCH_ROTATION(trigger)
  NEW_EPOCH( )
  # Subsequent receipts authenticate under the new epoch;
cross-epoch replay fails at VI
end procedure
procedure RETRY_ON_FAILURE(evt, ctr, t0, dt_bound)
  for i in 1..MAX_RETRIES:
    marker.flags.error = 1
    EMIT_MANAGEABILITY_RECEIPT(evt, ctr, t0, dt_bound)
    if LAST_TX_STATUS( ) == OK:
      return
    end if
  end for
  LOG(“Receipt emission failed after retries for ctr=” +
ctr)
end procedure
```

Conformance harness 1762 (black-box certification)

```
procedure CONFORMANCE_TEST(profile)
  SETUP_PASSIVE_TAP( )
  seq = [EV_DISC_ENUM, EV_ENUM_AUTH, EV_AUTH_EN,
EV_EN_RESET, EV_EN_QUIESCE, EV_QUIESCE_RET]
  for ev in seq:
    REQUEST_TRANSITION(ev)
    cap = WAIT_FOR_MARKER(ev, within=PROFILE_DT(ev))
    ASSERT(cap.found, “Missing marker for ev=” + ev)
    ASSERT(CANONICAL_ORDER_OK(cap.payload_headers),
“Non-canonical fields”)
    ASSERT(COUNTER_INCREMENTED(cap), “Lifecycle counter
did not increment”)
    ASSERT(VI_ATTEST_TAG(cap.marker.ep,
cap.payload_fields, cap.tag), “Tag invalid”)
    if HAS_LEDGER( ):
      proof =
VI_GET_INCLUSION_PROOF(hash(cap.payload_canonical))
      ASSERT(VERIFY_PROOF(proof,
LAST_ANCHOR( ).root_hash), “Merkle proof invalid”)
    end if
    if ev == EV_AUTH_EN:
      ASSERT(ENABLE_OCCURRED_AFTER(cap.timestamp),
“Enable occurred before validating receipt”)
    end if
  end for
  REPORT_PASS( )
end procedure
```

Failure diagnostics (power loss, counter wrap, director failover)

```
procedure ON_POWER_LOSS_DURING_LST(chiplet_or_partition)
  EMIT_DIAGNOSTIC_RECEIPT(event=“reset_diagnostic”,
rc=“power_loss”)
  HOLD_ENABLE_GATE(chiplet_or_partition)
end procedure
procedure ON_COUNTER_WRAP(chiplet or partition)
  EMIT_DIAGNOSTIC_RECEIPT(event=“ctr_wrap”,
rc=“ctr_wrap”)
  REQUIRE_QUIESCE_RETIRE(chiplet_or_partition) #
before rediscovery
end procedure
procedure DIRECTOR_TAKEOVER( )
  EMIT_DIAGNOSTIC_RECEIPT(event=“dir_takeover”,
rc=“dir_takeover”)
  REESTABLISH_EPOCH_AND_MERKLE( )
  # Gate remains closed until normal receipts validate
under current epoch
end procedure
```

These procedures demonstrate how unsolicited, time-bounded receipts are emitted on 1710, authenticated under epoch keys in 1780, anchored via 1740/1742/1744, verified through 1750, and enforced by the enable gate at 1720, with a harness 1762 providing black-box certification.

### REFERENCE NUMERALS

Numeral 1710 denotes the management link used to carry lifecycle, health, provisioning, and audit traffic independently of dataplane traffic.

Numeral 1712a-1712n denotes representative chiplets within the multi-die package; suffixes a-n indicate distinct instances or functional partitions of the same die type.

Numeral 1720 denotes the management director that coordinates discovery, authentication, enablement, quiescence, reset, retirement, and audit across multiple chiplets.

Numeral 1722 denotes the lifecycle state machine maintained per chiplet (or partition) to track and control progression through defined states.

Numeral 1730 denotes the receipt engine that constructs and emits manageability receipts when a lifecycle state transition is detected.

Numeral 1740 denotes the ledger service that commits compact receipt summaries to a tamper-evident structure.

Numeral 1741 denotes a Merkle leaf hash derived from canonical receipt content.

Numeral 1742 denotes the Merkle tree that accumulates leaves within an anchor window.

Numeral 1744 denotes the anchor artifact that commits the current Merkle root for a period or window.

Numeral 1750 denotes the verification interface that attests cryptographic fields and returns inclusion proofs to authorized requesters.

Numeral 1760 denotes an external verifier or audit client that consumes attestations and inclusion proofs for certification or forensics.

Numeral 1762 denotes a conformance harness used to drive scripted lifecycle transitions and capture passive evidence on the management link.

Numeral 1780 denotes the key boundary or hardware security module that derives per-epoch keys and performs cryptographic operations for receipts.

### Scope of the Inventions

The scope of the inventions is defined by the claims. The descriptions herein and the associated reference numerals are illustrative examples to enable practice; they do not limit claim breadth unless expressly recited. Functional blocks identified by numerals (for example, 1710, 1720, 1722, 1730, 1740, 1741, 1742, 1744, 1750, 1760, 1780) may be combined, partitioned, replicated, virtualized, or realized in hardware, firmware, software, or any combination thereof.

The inventions are transport-agnostic. A manageability receipt may traverse a sideband link or a management channel encapsulated in another interconnect while preserving an externally parseable marker on 1710; the marker's exact length, field order, or encoding may vary. Likewise, the canonical payload may be serialized as TLV, CBOR, fixed fields, or another deterministic schema, with field sizes chosen to suit implementation constraints, provided that receipt semantics—unsolicited emission at defined lifecycle transitions, external observability of a marker, and cryptographic binding of payload context—are maintained.

Cryptographic primitives are exemplary. Authenticated encryption may be realized with any suitable construction; integrity/authentication may use message authentication codes, forward-secure signatures, attestable tokens, or equivalent proofs. Epoch derivation within 1780 may use any approved KDF; epoch cadence and triggers are design choices. Monotonic counters may be per chiplet, per partition, per function, or hierarchically composed; counter width and wrap policy are profile parameters.

Gating semantics are general. Although an authenticate-to-enable edge is emphasized, the director 1720 (or distributed logic that provides equivalent control) may gate additional state changes, or apply policy predicates over measurement digests, proofs, or tokens. “Chiplet” encompasses partitions of a die and multi-die assemblies; topology locators cover 2D placements, 3D stacks, reticle coordinates, or logical slots.

Anchoring is optional and technology-neutral. A ledger service 1740 may use Merkle structures 1742, vector commitments, accumulators, or other transparency mechanisms; anchors 1744 may be private, public, or regulator-accessible; proofs may be served by 1750 or exported for offline verification. Absence of anchoring does not negate receipt semantics when claims do not require it.

Deployment scope extends beyond in-package interconnects. The same receipt semantics apply at board, backplane, rack, or cross-chassis boundaries, and across multi-package systems, provided that receipts remain unsolicited at lifecycle transitions, a clear marker is externally observable on 1710, and payload context is bound cryptographically and verifiable (for example, via 1750 by 1760).

Terminology is non-limiting. “Includes,” “including,” “comprises,” and “comprising” are open-ended; “or” is inclusive; “first,” “second,” etc., are labels, not priorities; conditional constructions (e.g., “may,” “can”) describe optional, independent features. Pseudocode and timing values are exemplary; profiles may tighten or relax bounds without departing from the inventions so long as the core properties—unsolicited emission, marker observability, canonical context binding, and enforceable lifecycle control—are preserved.

It is to be understood that the inventions disclosed herein are not limited to the exact details of construction, operation, exact materials or embodiments shown and described. Although specific embodiments of the inventions have been described, various modifications, alterations, alternative constructions, and equivalents are also encompassed within the scope of the inventions. Although the present inventions may have been described using a particular series of steps, it should be apparent to those skilled in the art that the scope of the present inventions is not limited to the described series of steps. The specification and drawings are, accordingly, to be regarded in an illustrative rather than a restrictive sense. It will be evident that additions, subtractions, deletions, and other modifications and changes may be made thereunto without departing from the broader spirit and scope of the inventions as set forth in the claims set forth below. Accordingly, the inventions are therefore to be limited only by the scope of the appended claims. None of the claim language should be interpreted pursuant to 35 U.S.C. 112(f) unless the word “means” is recited in any of the claim language, and then only with respect to any recited “means” limitation.

### Security and Privacy Considerations

The mechanism is designed so lifecycle evidence is externally visible while sensitive configuration remains confidential. A minimal, clear-text marker on 1710 indicates that a receipt was emitted and identifies the transition and epoch; detailed context resides in the protected payload. When authenticated encryption is used, the marker is supplied as associated data so that any alteration or stripping on 1710 causes integrity failure at the receiver.

Authenticity and context binding derive from per-epoch keys held inside 1780 and from a monotonic lifecycle counter serialized in canonical order by the receipt engine 1730. The epoch identifier in both marker and payload prevents cross-epoch replay, and the counter prevents duplication or reordering. Where link-layer protection is present, the marker remains visible on 1710 and is duplicated into the link's associated data to make tunneling or substitution detectable.

Privacy is preserved by carrying only compact digests and identifiers in the payload; raw manifests and fuse values are not exposed on the link. If further minimization is required, chiplet identity may be epoch-scoped so that passive observers on 1710 cannot correlate across rotations; verification proceeds through 1750 without revealing secrets. Anchoring through the ledger service 1740 stores only hashes (leaves 1741) in the Merkle tree 1742; anchors 1744 commit roots for later inclusion proofs without disclosing payload content.

Failure handling keeps observability intact and control safe. Under congestion, a marker-only pre-receipt can be emitted within the timing bound on 1710, followed by the complete payload when bandwidth permits; the enable gate at the director 1720 never lifts on a pre-receipt alone. If power loss, counter wrap, or director failover occurs, diagnostic receipts are emitted and anchors remain continuous so that an external verifier 1760 can reconstruct events via 1750. Conformance harnesses 1762 validate that these properties hold under test without requiring privileged access.

### Conformance and Certification

Conformance is established by demonstrating, under controlled conditions, that a device under test emits unsolicited manageability receipts at each defined lifecycle state transition, that the on-wire marker is present and well-formed on 1710, that the payload (where visible) follows canonical ordering, that the lifecycle counter increments exactly once per transition, that the cryptographic authenticator verifies for the indicated epoch via 1750, and that durable provenance is available through the ledger 1740, Merkle tree 1742, and anchors 1744. Certification is performed by passive observation of 1710 together with limited black-box queries to 1750; no privileged access to device internals is required.

A certification setup places the device under test in a reference topology with a conformance harness 1762, a passive tap on 1710, and scripted stimuli that drive discovery, enumeration, authentication, enablement, reset, quiescence, and retirement for representative chiplets 1712a-1712n. For each driven transition, the laboratory records the moment the transition is requested, the arrival time of the first byte of the receipt's marker on 1710, and any subsequent fragments or retries. Where payloads are encrypted, verification proceeds through 1750, which attests the authenticator for the epoch indicated by the marker and, when enabled, returns inclusion proofs for hashes committed by 1740 to 1742 under the current anchor 1744.

Acceptance criteria are objective. A device passes when (i) a receipt marker appears on 1710 within the configured window for every defined transition; (ii) payload headers, if visible, conform to canonical order and field encoding; (iii) the lifecycle counter increments once per transition and never regresses, including across retries; (iv) the authenticator validates for the epoch via 1750; (v) for at least a representative subset of receipts, inclusion proofs verify against the published anchor 1744; and (vi) enablement is not observed to occur before a validating authenticate-to-enable receipt. A device fails if any required transition lacks an observable marker on 1710, if markers are malformed, if ordering or counters are incorrect, if epoch binding or authenticator attestation fails at 1750, if anchors or proofs are unavailable where required, or if enablement occurs in the absence of validated evidence.

Path handling is explicit. In dual-path designs, emission on either a sideband path or a mainband-encapsulated path is acceptable provided that the marker remains visible on 1710 and, where link-layer protection is used, is bound as associated data so that stripping is detectable. If a vendor claims both paths, profile-specific tests may require demonstration on each. Timing, retry behavior, and degraded modes (such as pre-receipts) are evaluated against the profile in use; pre-receipts alone never satisfy enable-gate requirements at 1720.

Evidentiary artifacts from a successful session include packet traces from 1710, human-readable decodes of markers (and payload headers where visible), tabulated lifecycle counters per transition, the attestation responses from 1750, anchors emitted via 1744, and inclusion proofs bound to roots from 1742. These artifacts are signed by the laboratory and maintained with a chain-of-custody statement so that they can support audits and comparative testing across vendors. Because observability is by design, the same suite and artifacts can be reused across product lines and releases without vendor-specific tooling.

### Detectability

Practice of the inventions can be established by black-box observation without privileged access or vendor cooperation. A third party instruments the management link 1710, drives ordinary lifecycle activity (discovery, enumeration, authentication, enablement, reset, quiescence, retirement), and verifies that, for each defined transition, a receipt marker appears on 1710 within the expected window. Because the marker is clear text by design, its presence, version, event code, and epoch identifier are readable from a packet capture alone.

Where payloads are encrypted, decryption is unnecessary to show practice. The combination of (i) mandatory emission on 1710, (ii) a stable marker format, and (iii) the requirement that enablement not occur before the corresponding receipt allows practice to be proven from captures and observable state changes. If stronger confirmation is desired, a claimant can query the verification interface 1750 to obtain an attestation that the cryptographic authenticator for the captured fields is valid in the indicated epoch and, if anchoring is implemented, an inclusion proof from the ledger service 1740 (leaf 1741) through the Merkle tree 1742 to the current anchor 1744. The proofs are machine-checkable by an external verifier 1760.

Common evasions are visible in the same capture. Pull-only attestation (no unsolicited emission) yields missing markers on 1710 at driven transitions. Local-only logs do not satisfy the on-wire presence requirement. Link-layer encryption that hides the marker fails conformance because the marker must remain visible on 1710; where encapsulation is used, the marker is bound as associated data so stripping produces a detectable integrity mismatch. In dual-path devices, the path indicator in the marker identifies whether the sideband or encapsulated route carried the receipt; silence on both paths during transitions evidences non-practice.

An evidentiary package typically includes: raw traces from 1710; a table listing, per transition, the captured marker fields (version, event, epoch) and arrival times; a monotonic counter log (when headers are visible or inferred); verification transcripts from 1750 (tag attestations and, if applicable, inclusion proofs); and anchors issued via 1744. For completeness, a short script or harness 1762 that triggered the transitions is included so the capture can be replicated. Because observability is normative and wire-visible, these artifacts suffice to demonstrate practice (or non-practice) without reverse-engineering internals of 1720, 1722, 1730, or 1780.

### Manufacturing, Provisioning and Deployment (Illustrative)

Manufacturing begins with assignment of stable identities to chiplets 1712a-1712n. During wafer sort or final test, each die is programmed with an electrical chip identifier and any fuses required for configuration policy; the resulting identity is exported to the packaging house together with a minimal manifest digest for later comparison. The package bill of materials lists the intended topology so that the topology locator encoded in receipts can be validated against known slot, stack, or three-dimensional coordinates.

At assembly, the packaging line integrates a lightweight director instance 1720 or an equivalent harness that exercises discovery and enumeration on the management link 1710. The harness verifies that each chiplet responds with discovery-to-enumeration receipts and that lifecycle counters increment from their initial values. Where a ledger service 1740 is present during manufacturing, leaves 1741 corresponding to these early transitions are committed to a local Merkle tree 1742 and an anchor 1744 is generated at the close of the lot; the anchor artifact accompanies the traveler records and enables later correlation in return-material authorization scenarios.

Provisioning of secrets is confined to a key boundary 1780. A sealed master is injected through a secure channel or derived inside 1780 from a device-unique secret so that per-epoch keys need not be transported. The verification interface 1750 on the bench accepts only authenticated requests from the manufacturing controller and returns tag attestations for sample receipts; no raw keys leave 1780. If a forward-secure signature profile is selected, the signing state is advanced to the first production epoch before shipment and the prior state is irreversibly erased.

Before release, a bring-up profile is executed end-to-end. The director 1720 runs the lifecycle state machine 1722 across discovery, authentication, and enablement, emitting receipts on 1710 within profile timing bounds and enforcing the enable gate on the authenticate-to-enable edge. Payload digests are compared, through 1750, to an allow-list corresponding to the golden firmware image. Any rework resets the epoch, increments counters in the normal course of transitions, and produces a fresh anchor 1744 that supersedes the earlier record; the superseded anchor remains available for forensic lineage.

Deployment into a host system repeats the essential steps with production timing and policy. The system integrator's controller assumes the role of 1720, or proxies to it, and verifies through a passive tap on 1710 that receipts appear at installation, service, and retirement. For fleets, a central registry ingests anchors 1744 published by 1720 across devices and exposes proofs via 1750 to authorized tools; this permits change tickets and compliance records to bind directly to the underlying lifecycle evidence without vendor-specific instrumentation.

Service and RMA flows preserve the evidence chain. When a module returns, a bench harness 1762 replays discovery and authentication; if counters or epochs do not align with the shipped anchor, the discrepancy is recorded. If failure analysis requires reflashing or fuse repair, the operation is performed under a new epoch; subsequent receipts and anchors reflect the change so that the field and lab records remain reconciled. Throughout, receipts on 1710 remain visible, counters remain monotonic per chiplet or partition, and proofs from 1750 verify that the artifacts belong to the correct anchor window.

These manufacturing and deployment practices ensure that the manageability receipts are present from first discovery through field operation, that secrets remain confined to 1780, and that anchors and proofs are available across the product life cycle for certification, forensics, and supply-chain verification, all without exposing sensitive configuration on the link.

### Computer Program Product and Hardware Realization

The functional elements described may be realized in hardware, software, firmware, or any combination thereof. In a software realization, operations of the management director 1720, lifecycle state machine 1722, receipt engine 1730, ledger service 1740, and verification interface 1750 are embodied as program instructions stored on a non-transitory computer-readable medium and executed by one or more processors. The medium can include semiconductor memory, magnetic or optical storage, or solid-state storage integrated within or coupled to the package that exposes the management link 1710.

In a hardware realization, control logic for the director 1720 and receipt engine 1730 may be implemented as microcontroller firmware, programmable logic (e.g., FPGA fabric), or fixed-function state machines within an ASIC. Cryptographic operations and epoch key derivation are preferably confined to a boundary implemented as a secure element or enclave denoted 1780, which provides isolated key storage, deterministic derivation of per-epoch keys, and authenticated services used by higher-level code. The ledger service 1740 can maintain Merkle state 1742 either in on-die SRAM or in attached memory, with anchors emitted by 1744 through a management stack reachable over 1710 or via a host interface.

Topology detection and identity sources for chiplets 1712a-1712n may be supplied by embedded fuses, device certificates, or ECIDs read during discovery; the director 1720 maps these inputs to canonical topology locators and chiplet identifiers prior to constructing receipts. Timekeeping for receipt timestamps can be derived from a local tick counter synchronized at bring-up; if absolute time is required, anchors produced by 1744 may incorporate trusted timestamps while the on-link receipts retain relative ticks for robustness.

The verification interface 1750 can be presented as a memory-mapped service within the package, as a secure RPC reachable over 1710, or as a host-side verifier that consumes receipt fields provided by the director 1720 while still relying on cryptographic material resident in 1780. External verifier tooling 1760 interacts with 1750 to obtain tag attestations and, if enabled, inclusion proofs derived from leaves 1741 in the Merkle tree 1742. In fleet deployments, a supervisory controller aggregates anchors from 1744 and exposes a registry against which proofs supplied by 1750 can be checked.

Signal integrity and transport choices on 1710 are implementation details; the inventions require only that a clear-text marker be present on the management path at defined lifecycle transitions and that the payload be serialized in a canonical order with a cryptographic authenticator. Whether 1710 is a dedicated sideband, a tunneled channel over a primary interconnect, or a low-speed service bus, the observable properties of the marker and the gating and verification behaviors of 1720, 1730, 1740, 1742, 1744, 1750, and 1780 remain as described.

### Parameter Ranges and Representative Values

Unless stated otherwise, ranges recited herein are inclusive and may encompass any sub-range therein; numerical values may be “about” the recited number. In certain embodiments, a receipt emission window (Delta t) is from about 10 ms to about 200 ms. In particular embodiments, Delta t for bring-up edges (e.g., discovery, authentication, enablement) is from about 10 ms to about 50 ms, and Delta t for service edges (e.g., reset, quiescence, retirement) is no more than about 50 ms. In some embodiments, a marker is observable on 1710 within the applicable Delta t measured from detection of the lifecycle state transition.

In certain embodiments, a lifecycle counter has a width from about 16 bits to about 64 bits; in particular embodiments, the counter is 32 bits and increments exactly once per transition without regression across retries. An epoch identifier may be from about 8 bits to about 32 bits and may wrap per policy. A director-relative tick used for timestamps may be from about 32 bits to about 64 bits with a resolution from about 0.5 ms to about 5 ms; in particular embodiments, a 48-bit tick at approximately 1 ms resolution is employed.

In some embodiments, a clear-text marker conveyed on 1710 has a length from about 4 bytes to about 8 bytes and includes at least a type, version, event, and epoch field; in particular embodiments, a 5-byte marker is used. In certain embodiments, a canonical payload is serialized in a fixed order and includes a topology locator (about 4-16 bytes), a chiplet identifier (about 8-32 bytes, e.g., ECID/EUID), a measurement digest (about 16-64 bytes, e.g., SHA-256 at 32 bytes), a result code (about 1-2 bytes), a timestamp, the lifecycle counter, and a cryptographic authenticator truncated to about 8-16 bytes; in particular embodiments, a 12-byte truncation is used.

In certain embodiments, payload integrity and/or confidentiality is provided by an authenticated-encryption scheme (e.g., an AEAD construction) with the clear-text marker supplied as associated data; in some embodiments, integrity is provided by a message authentication code or by a forward-secure signature of comparable strength. Epoch keys may be derived within a key boundary 1780 using a key-derivation function; nonces may be formed from an epoch value, a sender identifier, and a per-epoch sequence so as to avoid reuse. Epoch rotation may be triggered by time expiry (e.g., about 1-60 minutes), by a topology change, or by a policy update.

In particular embodiments, when link conditions risk exceeding Delta t, a marker-only pre-receipt is emitted promptly, followed by a complete payload within the applicable Delta t; the fragments may share a nonce for correlation, and pre-receipts do not satisfy enable-gate conditions. In some embodiments, the number of retries is limited (e.g., about 1-3), with error indication set and the lifecycle counter not advanced by retries.

In certain embodiments, receipts are summarized by a ledger service 1740 as leaves 1741 within a Merkle structure 1742; anchors 1744 are published on a cadence from about 10 seconds to about 600 seconds or after about 512-4096 receipts, whichever occurs first. An inclusion proof length may be commensurate with tree height (e.g., about 3-20 siblings). A verification interface 1750 may return authenticator attestations and inclusion proofs with target latencies suitable for local or fleet operation.

Nothing in this section limits the claims unless expressly recited; parameters may be selected, interchanged, or tuned to meet system constraints provided that a clear-text marker remains observable on 1710, a canonical context is cryptographically bound, unsolicited emission occurs at defined lifecycle transitions, and, where claimed, enablement at a director 1720 is conditioned on validated evidence and/or anchoring via 1740/1742/1744 with verification via 1750.

### Transport Mappings (Informative Examples)

This section illustrates exemplary on-wire mappings that preserve the externally parseable marker on 1710 and the canonical, cryptographically bound payload, while permitting differing physical or logical transports. Field sizes and encodings are illustrative and may be tuned per profile.

### Sideband Mapping (Fixed-Width Frame).

A dedicated sideband on 1710 conveys a 5-byte clear-text marker followed by the canonical payload serialized as TLVs. Marker fields comprise: type (1 byte), version (1), event (1), epoch (1), flags (1). The payload follows in fixed order and may be protected with authenticated encryption; the marker is included as associated data. The director 1720 emits the frame within the applicable timing window, and the receipt engine 1730 appends a leaf hash to the ledger service 1740 for aggregation in the Merkle tree 1742 and anchoring via 1744. The verification interface 1750 later attests payload authenticity for an external verifier 1760.

### Encapsulated Management Channel (Tunneled Over Primary Fabric).

Where manageability is encapsulated, the same clear-text marker is replicated into the link layer's associated-data path so that any mismatch between the on-wire marker and the bound marker is detectable. The payload is carried in the tunneled body and authenticated under epoch keys held in 1780. Path selection is recorded in the marker's flags; passive tools capturing 1710 can still confirm presence, version, event, and epoch without decrypting the payload. The lifecycle state machine 1722 and enable-gate semantics remain unchanged.

### Low-Speed Service Bus Profile (Fragmented Payload).

On constrained links, the director 1720 transmits the marker first and may fragment the payload into short segments that collectively complete within the timing window. If congestion threatens the bound, a pre-receipt consisting of the marker and a nonce is sent immediately, followed by the authenticated payload that reuses the nonce for correlation. Retries set an error indication in the marker; the lifecycle counter does not advance on retries; anchoring through 1740 proceeds on first successful completion.

### Dual-Path Devices (Sideband Plus Encapsulated).

Devices with both paths implement a policy that prefers the sideband for observability and falls back to encapsulation as needed; the marker's path bit indicates the actual carrier. Certification accepts either path provided the marker remains visible on 1710; profiles may require demonstration on both. In all cases the verification interface 1750 attests tags computed under keys confined to 1780 and, where enabled, returns inclusion proofs that bind leaves 1741 from 1742 to anchors 1744.

### Host-Mediated Verifier.

In some deployments, 1750 is exposed via a host interface while the marker remains visible on 1710. The director 1720 forwards canonical payload headers (not secrets) to the host-side verifier, which performs attestation using material sealed within 1780. External tools 1760 query the host mediator for tag results and proofs. This arrangement preserves on-wire observability and keeps cryptographic operations inside the key boundary while simplifying integration with existing host management stacks.

### Inter-Package Extension.

Where receipts traverse an inter-package fabric before reaching 1720, the marker is preserved end-to-end, and payload integrity is verified at 1750 under keys in 1780. Anchors 1744 may bind receipts from several packages into a unified tree 1742 served by 1740, enabling fleet-level proofs without altering marker visibility on 1710.

### Interoperability Profiles and Compliance Classes

This section sets forth exemplary profiles and compliance classes to promote predictable behavior across vendors while permitting product-specific variation. Profiles define which behaviors are mandatory, which are optional, and how timing, path usage, and evidentiary outputs are verified on the management link 1710 with respect to the director 1720, lifecycle state machine 1722, receipt engine 1730, ledger service 1740 (Merkle 1742, anchors 1744), and verification interface 1750 consumed by an external verifier 1760.

Compliance Class M (Manageability). A device conforming to Class M shall: (i) emit unsolicited manageability receipts at each defined lifecycle state transition with a clear-text marker visible on 1710; (ii) serialize a canonical payload containing at least a chiplet identifier, a topology locator, a monotonic lifecycle counter, an epoch identifier, a time value, and a cryptographic authenticator; (iii) maintain per-chiplet or per-partition counters that increment exactly once per transition; (iv) bind receipts to epochs derived within a key boundary 1780; (v) in profiles that gate enablement, refuse entry into enabled state until a validating authenticate-to-enable receipt exists; and (vi) where anchoring is implemented, commit receipt hashes as leaves 1741 and publish anchors 1744 from 1742, with proofs available through 1750.

Profile BR (Bring-Up). Intended for assembly, lab integration, and early field trials. Emission windows may be wider than production, and a marker-only pre-receipt is permitted when congestion threatens timing. Either a sideband or encapsulated path on 1710 is acceptable; the marker remains visible and, when encapsulated, is duplicated into associated data. Anchors may be local to the lab registry; proofs returned by 1750 suffice for certification snapshots. Enable-gate policy may be relaxed for non-safety transitions; the authenticate-to-enable edge remains gated where specified.

Profile PR (Production). Used in shipping products and customer qualification. Emission windows are tightened; retries are bounded; pre-receipts are allowed only under explicit congestion and must be completed within the window. The marker is always visible on 1710; if both a sideband and an encapsulated path exist, at least one must carry receipts continuously, and the marker's path bit reflects the active route. Anchors produced by 1744 are available to authorized tools, and proofs from 1750 verify a representative subset of receipts under each anchor period. The authenticate-to-enable edge is gated; other edges may be gated per policy.

Profile SC (Safety-Critical). For automotive, avionics, medical, or other regulated contexts. Emission windows are the strictest; degraded modes are limited to bring-up and are prohibited during operation affecting safety functions. Redundant directors cross-check anchors from 1744 and refuse enablement during takeover unless continuity of 1742 is proven. The verification interface 1750 supports bounded-latency attestation suitable for safety cases. Where privacy is required, chiplet identity in the payload may be epoch-scoped while the marker on 1710 remains minimal and stable.

Dual-Path Requirement. Devices that advertise both a sideband and an encapsulated management channel shall document a priority rule and expose the active path via the marker. Certification accepts either path provided the marker remains visible on 1710 and, when encapsulated, is bound as associated data so that stripping is detectable. If a vendor claims dual-path support, conformance testing exercises both.

Evidence and Artifacts. For each profile, a conforming implementation supplies packet traces captured on 1710, decodes of markers (and visible payload headers), lifecycle counter tables, tag attestations and inclusion proofs from 1750, and anchor artifacts emitted via 1744. Artifacts are sufficient for third-party verification without privileged access to 1720, 1722, 1730, or 1780.

Versioning. Marker and payload versions are independent; profile conformance attaches to a specific pair. Unknown payload TLVs are ignored without reordering; canonical ordering for known fields is preserved so that tools can parse captures consistently from 1710.

These profiles are illustrative. Other profiles may be defined, provided that core properties are maintained: unsolicited on-wire receipts at the defined lifecycle edges, a visible marker on 1710, canonical payload ordering with counter and epoch binding under keys in 1780, enforceable gating where specified, and—when implemented—anchoring through 1740/1742/1744 with proofs via 1750 accessible to 1760.

### Test Vectors and Wire Examples

The following wire-level examples are provided to illustrate representative embodiments and are not limiting. Unless stated otherwise, values are exemplary and may be varied within the ranges disclosed herein. In each example, a clear-text marker is conveyed on 1710, canonical payload fields are serialized in a fixed order, cryptographic material is confined to 1780, ledger operations are performed by 1740 over 1742 with anchors emitted by 1744, and verification is exposed through 1750 to an external verifier 1760.

Example A (Authenticate->Enable; sideband, no fragmentation). In one embodiment, a director 1720 detects an authenticate->enable transition having event code 0x03 for a chiplet (e.g., 1712a) during epoch 0x12. A 5-byte clear-text marker appears on 1710 within the applicable emission window and includes: type 0x5A, version 0x01, event 0x03, epoch 0x12, and a flags byte indicating presence. A canonical payload follows in fixed order and, prior to protection, includes: a payload version, the event code (repeated for integrity), a topology locator, a chiplet identifier, a measurement digest (e.g., a 32-byte SHA-256), a monotonic lifecycle counter value, the epoch identifier, a result code of 0x0000, a director-relative timestamp, and a cryptographic authenticator. In particular embodiments, the payload is protected using an AEAD construction with the marker supplied as associated data, and the authenticator is a truncated HMAC (e.g., 96 bits) computed over the canonical payload with a per-epoch key derived inside 1780. The transmitted frame thus consists of the marker on 1710 and an authenticated ciphertext for the canonical payload. A leaf hash derived from the canonical payload and authenticator is appended by 1740 to 1742, and an anchor is subsequently published by 1744. The interface 1750 attests the authenticator for the indicated epoch and, if anchoring is enabled, returns an inclusion proof verifiable by 1760 against the current anchor.

Example B (Pre-receipt and completion under congestion). In certain embodiments, when link conditions risk violating the emission window, the director 1720 immediately transmits on 1710 a marker-only pre-receipt indicating the relevant event and epoch and carrying a nonce for correlation. A complete, authenticated payload then follows within the same emission window and echoes the nonce. The enable gate at 1720 does not lift on a pre-receipt alone; enablement proceeds only after a validating receipt is observed for the transition.

Example C (Epoch rotation during transition). In some embodiments, an event begins during one epoch and completes after policy or topology changes advance the epoch. The finished receipt carries the new epoch identifier in both marker and payload, and the authenticator is computed under the new epoch key within 1780. Any attempt to validate an older receipt under the new epoch is rejected by 1750. Where a pre-receipt was transmitted before rotation, the completion payload reuses the pre-receipt's nonce to preserve correlation across the boundary.

Example D (Authenticator failure and bounded retry). In certain embodiments, if 1750 reports that an authenticator is invalid for the epoch and fields presented, the director 1720 emits a bounded number of retries. Retries set an error indication in the marker, may set a non-zero result code (e.g., 0x0002), and do not advance the lifecycle counter. Both failed and successful emissions may be summarized by 1740 in 1742 and covered by the next anchor of 1744, permitting later forensic analysis.

Encapsulated transport mapping. Where manageability is tunneled rather than conveyed on a dedicated sideband, the marker remains visible on 1710 and is duplicated into a link-layer associated-data path so that stripping or substitution is detectable. Payload integrity continues to verify at 1750 under keys confined to 1780; ledger and anchor behavior at 1740/1742/1744 is unchanged.

Conformance note. For each illustrative case, a harness 1762 may record the time a transition was requested, the arrival time of the first byte of the marker on 1710, the presence and shape of any pre-receipt, completion within the applicable emission window, the lifecycle counter increment, authenticator attestation from 1750, and—where enabled—verification of an inclusion proof against an anchor from 1744. A device passes when all driven transitions exhibit on-wire markers within the window, counters are monotonic, authenticators validate through 1750, and, for authenticate->enable, enablement is not observed prior to a validating receipt.

### Enable-Gate Policies and State-Machine Extensions

In certain embodiments, enablement of a chiplet or functional partition proceeds only upon satisfaction of a policy predicate evaluated by the management director 1720 over evidence conveyed in a manageability receipt on 1710 and, where implemented, over attestation results returned by the verification interface 1750. A baseline policy requires that an authenticate-to-enable transition be accompanied by a validating cryptographic authenticator bound to the epoch in effect and, optionally, that a measurement digest reflect a configuration on an allow-list. Policies may further incorporate time-to-enable bounds, quorum approvals, or dependency checks across multiple chiplets 1712a-1712n.

The lifecycle state machine 1722 may be extended with guarded edges and substates to express these constraints without altering the mandatory receipt semantics. For example, an intermediate “enable-pending” substate may be entered upon emission of an authenticate-to-enable receipt; the transition to “enabled” occurs only after a positive attestation from 1750 and, if required, a policy token check or multi-party authorization. Where multiple chiplets must satisfy prerequisites before enablement of a shared resource, the director 1720 may maintain a dependency set and require that each member contribute a validating receipt within a coordination window prior to releasing the gate.

Policies may be differentiated by profile. In a bring-up profile, enablement may be allowed when the authenticator validates even if a measurement digest is absent, provided a degraded-mode indication is set and recorded by the ledger service 1740. In production profiles, enablement requires both authenticator validation and a positive policy decision; any negative result leaves the chiplet in a quiescent or diagnostic substate and records an error class for later audit. In safety-critical profiles, redundant directors cross-check anchors emitted via 1744 and refuse enablement during takeover unless continuity of the Merkle structure 1742 is proven and policy predicates are re-evaluated.

Extensions to the state machine may also cover service operations. Exiting quiescence or clearing a reset may be gated on a validating receipt when policy demands, preventing silent resumption after drift or tampering. Retirement may require a terminal receipt that freezes the lifecycle counter for that identity, ensuring that any subsequent discovery sequence is unambiguously recognized as a fresh instance. In all cases, receipts remain unsolicited at the defined edges and the clear-text marker remains observable on 1710, while enforcement logic in 1720 evaluates the necessary predicates using evidence bound under keys confined to 1780 and, where enabled, verifications provided by 1750.

### Claim Construction and Section 112 Notes

Unless expressly stated otherwise, terms used in the specification and claims are to be given their ordinary and customary meaning to a person of ordinary skill in the art at the time of filing. The transitional terms “comprising,” “including,” and “having” are open-ended and do not exclude additional, unrecited elements or steps. The terms “a,” “an,” and “the” encompass singular and plural forms unless the context clearly dictates otherwise. Conjunctive language such as “at least one of A, B, or C” is intended to mean A alone, B alone, C alone, or any combination thereof.

Ranges recited herein are inclusive and support every sub-range and individual value within the stated bounds. Numerical values may be “about” the recited number, accounting for ordinary measurement tolerance and implementation variance consistent with the disclosed embodiments.

Recitations such as “configured to,” “operative to,” and “adapted to” indicate structural capability and are not intended to invoke 35 U.S.C. Section 112(f) absent use of the phrase “means for.” Elements recited without the words “means for” are not intended to be construed under Section 112(f). Where a function is expressly tied to disclosed structure in the specification, that structure and equivalents are contemplated. Steps in described methods need not be performed in the precise order written unless explicitly stated or logically required.

Headings are for convenience and shall not limit the scope. Examples and illustrative values are non-limiting unless explicitly claimed. The absence of a feature from a particular embodiment does not imply that the feature is foreclosed from the claimed inventions. Any incorporation by reference, if present, is limited to the extent permitted under applicable rules and does not admit material as prior art.

### CROSS-REFERENCE TO RELATED APPLICATIONS

This application claims no benefit of priority to any prior-filed United States or foreign patent application and is not a continuation, divisional, or continuation-in-part of any other application. No related applications are identified under 37 C.F.R. 1.78.

### STATEMENT REGARDING GOVERNMENT RIGHTS

No United States Government funding, support, or rights were involved in or are claimed for the inventions described herein. The United States Government does not have any rights in this application under 35 U.S.C. 200-212 or otherwise.

### INCORPORATION BY REFERENCE

To the extent permitted, any publications, standards specifications, and normative profiles cited in the Background or elsewhere in this specification are incorporated by reference in their entirety for all purposes consistent with the disclosed subject matter. Such incorporation by reference does not constitute an admission that any such document is prior art to the present application. In the event of any inconsistency between an incorporated document and the express disclosure herein, the present disclosure shall control.

### STANDARDS PARTICIPATION AND FRAND STATEMENT

The applicant anticipates participating in one or more industry standards activities relevant to the subject matter disclosed herein. To the extent any claim of an issued patent is determined to be essential to practicing a final, published, normative portion of a standard (i.e., unavoidably infringed by a compliant implementation), the applicant is willing to make such essential claims available for license on fair, reasonable, and non-discriminatory (FRAND) terms, subject to customary conditions including reciprocity and defensive suspension.

This statement is informational and does not, by itself, constitute a binding offer or a waiver of any rights. Any binding licensing commitment, if made, will be set forth in an executed letter of assurance or equivalent undertaking delivered to the applicable standards body and will define the scope (e.g., essential claims only), field of use (e.g., compliant implementations), and other terms consistent with that body's policies. Nothing herein admits essentiality, defines what is “essential,” or limits the scope of any present or future claims. Nothing herein obligates the applicant to license non-essential claims, non-compliant implementations, or uses outside the field of the standard. In the event of any inconsistency between this statement and a later letter of assurance accepted by a standards body, the latter shall control.

### CONCLUSION

The foregoing describes systems and methods by which lifecycle evidence is emitted unsolicited at defined transitions on a management link 1710, recorded in a canonical, cryptographically bound payload, and enforced by a management director 1720 through enable-gate policies. The disclosure sets forth representative structures (e.g., receipt engine 1730, ledger service 1740 with Merkle tree 1742 and anchors 1744, verification interface 1750) and operational sequences sufficient to enable practice across sideband and encapsulated transports, single-package and multi-package deployments, and diverse profiles ranging from bring-up to safety-critical operation. Variations in field sizes, encodings, cryptographic primitives, timing windows, and transport mappings are contemplated, provided that the essential properties—unsolicited on-wire emission at lifecycle boundaries, external observability of a clear marker, canonical payload binding with monotonic counters and epoch discipline, enforceable gating, and (where implemented) tamper-evident anchoring with verifiable proofs—are preserved. The scope of the inventions is defined by the claims.

1. A system comprising: a management network interconnecting a management controller and at least one chiplet within a multi-die package; logic configured to detect a lifecycle state transition of the chiplet; and a receipt engine configured, responsive to detecting the lifecycle state transition and without receiving a request, to transmit on the management network a manageability receipt having (i) a clear-text marker that identifies the message as a receipt and indicates at least an event associated with the lifecycle state transition, and (ii) a payload comprising at least three elements selected from the group consisting of: a chiplet identifier, a topology locator, a lifecycle counter, a time value, a policy or version indicator, a context identifier, a measurement digest, and a result indicator; the payload further including a cryptographic authenticator computed over at least a portion of the payload and binding the payload to a context value; wherein the manageability receipt is externally observable at a protocol boundary of the management network by virtue of the clear-text marker.

1. The system of claim 1, wherein the payload comprises at least five of the elements recited in claim 1.

2. The system of claim 1, wherein the clear-text marker further indicates at least a protocol version and a context identifier corresponding to an operational context in which the lifecycle state transition occurred.

3. The system of claim 1, wherein the payload further comprises a measurement digest of firmware, fuse, or configuration state.

4. The system of claim 1, wherein the manageability receipt is transmitted within a bounded interval from detecting the lifecycle state transition and, when the lifecycle state transition leads toward an operational state, before enabling the next state.

5. The system of claim 1, wherein emission of the manageability receipt is mandatory for at least one lifecycle state transition selected from the group consisting of: discovery-to-enumeration, enumeration-to-authentication, authentication-to-enablement, enablement-to-reset, enablement-to-quiescence, and quiescence-to-retirement.

6. The system of claim 1, wherein the payload is protected by authenticated encryption and the clear-text marker is included as associated data such that alteration of the marker is detectable.

7. The system of claim 1, wherein link-layer protection preserves the clear-text marker on the management network and binds the marker as associated data so that stripping or substitution is detectable.

8. The system of claim 1, wherein the lifecycle counter is maintained per chiplet or per functional partition and increments exactly once per lifecycle state transition.

9. The system of claim 1, wherein the topology locator encodes at least one of: a slot index, a stack index, a functional partition identifier, or a three-dimensional coordinate within a stacked assembly.

10. A computer-implemented method comprising: detecting, at a management controller or at a chiplet, a lifecycle state transition of a chiplet within a multi-die package; without receiving a request, transmitting on a management network a manageability receipt that includes a clear-text marker identifying the message as a receipt and indicating at least an event associated with the lifecycle state transition, and a payload comprising at least three elements selected from the group consisting of: a chiplet identifier, a topology locator, a lifecycle counter, a time value, a policy or version indicator, a context identifier, a measurement digest, and a result indicator; computing and including in the payload a cryptographic authenticator over at least a portion of the payload so as to bind the payload to a context value; and thereby making the manageability receipt externally observable at a protocol boundary of the management network.

11. The method of claim 11, further comprising transmitting the manageability receipt within a bounded interval from detecting the lifecycle state transition and, when applicable, before enabling a next operational state.

12. The method of claim 11, wherein the payload is protected by authenticated encryption and the clear-text marker is included as associated data.

13. The method of claim 11, further comprising computing a hash of the receipt as a leaf of a commitment structure, publishing an anchor comprising a root of the structure for a period, and returning an inclusion proof for the leaf responsive to a verification query.

14. The method of claim 11, wherein the lifecycle counter increments exactly once per lifecycle state transition and does not regress across retries.

15. The method of claim 11, wherein the clear-text marker further indicates a path on which the receipt was carried, the path being a sideband manageability path or a mainband-encapsulated path.

16. A non-transitory computer-readable medium storing instructions that, when executed by one or more processors, cause the processors to perform operations comprising the steps of claim 11.

17. The system of claim 1, wherein when immediate full-payload transmission would violate the bounded interval, a marker-only pre-receipt is transmitted and a complete payload follows within the bounded interval, the pre-receipt and payload sharing a nonce.

18. The system of claim 1, further comprising a gate controller configured to prevent transition to an enabled operational state unless a manageability receipt corresponding to an authenticate-to-enable transition has been transmitted and validated.

19. The system of claim 1, further comprising a ledger service configured to hash receipt content as a leaf of a commitment structure and to publish an anchor comprising a root of the structure for a period, and a verification interface configured to return an inclusion proof for a provided receipt.

20. A system comprising: a computing platform including a device component selected from the group consisting of a die, a chiplet, a module, a board-level field-replaceable unit, a functional partition, and a software-controlled subsystem; a communication path providing an externally accessible protocol boundary; logic configured to detect a state change of the device component; and a transmitter configured, responsive to detecting the state change and without receiving a request, to place on the communication path a receipt message having (i) a clear-text marker that identifies the message as a receipt and indicates at least an event associated with the state change, and (ii) a payload comprising at least three elements selected from the group consisting of: a component identifier, a locator of the component, a counter, a time value, a policy or version indicator, a context identifier, a measurement digest, and a result indicator; the payload further including a cryptographic authenticator computed over at least a portion of the payload and binding the payload to a context value; wherein the receipt message is externally observable at the protocol boundary by virtue of the clear-text marker.
